(19) United States
(12) Patent Application Publication
(10) Pub. No.: US 2025/0004809 A1
(43) Pub. Date: Jan. 2, 2025

(54) DYNAMIC VIRTUAL MACHINE SCHEDULING IN A HIGH-AVAILABILITY INFRASTRUCTURE THAT SUPPORTS VIRTUAL MACHINE MIGRATIONS

(71) Applicant: Nutanix, Inc., San Jose, CA (US)

(72) Inventors: Fabien HERMENIER, Grasse (FR); Danilo MEDJO, Belgrade (RS)

(73) Assignee: Nutanix, Inc., San Jose, CA (US)

(21) Appl. No.: 18/217,421

(22) Filed: Jun. 30, 2023

(51) Int. Cl. G06F 9/455

(52) U.S. Cl. CPC G06F 9/45558; G06F 2009/4557

(57) ABSTRACT

Methods, systems, and computer program products for high-availability virtualized computing clusters. Components are operatively interconnected to carry out operations for maintaining high-availability configurations of such virtualized computing clusters. A virtual machine in a source computing node of a virtualized high-availability multi-node computing cluster is considered for migration in a manner that observes high-availability rules. A scheduler and/or a placement engine is configured to identify one or more feasible HA-compliant virtual machine placements. The scheduler and/or a placement engine and/or their agents are configured to respond to a virtual machine migration request by establishing a placeholder at a target computing node so as to reserve resources of the target computing node. The virtual machine is migrated from the source computing node to the target computing node using the reserved resources. After migration, the configuration of the cluster satisfies high-availability requirements including any anti-affinity rules and/or high-availability reboot rules.

### TECHNICAL FIELD

This disclosure relates to virtualized computing clusters, and more particularly to techniques for dynamic virtual machine scheduling in a high-availability infrastructure that supports virtual machine migrations.

### BACKGROUND

Many modern configurations of computing clusters rely on multi-node infrastructure that supports virtualized componentry. For example, many modern computing clusters host virtualization system components such as hypervisors, virtual memory, virtualized storage devices, and other components that can be used by computing processes called virtual machines (VMs). Among other benefits afforded by hosting virtualized componentry on the computing infrastructure are (1) the ease of adding or removing a computing node to/from a computing cluster, and correspondingly, (2) the ease (e.g., low computing cost) with which a virtual machine can be migrated between computing nodes. In particular the ease with which a virtual machine can be migrated between computing nodes demands implementation of many regimes that support deterministic growth or contraction of a computing cluster as virtual machines are created or destroyed.

As time has progressed, so have the demands for greater and greater guarantees of high availability of VMs. In the face of demands for greater and greater guarantees of high availability of VMs, so have come demands for more and more efficient (e.g., cheaper and cheaper) management of VMs as they are created and destroyed.

Unfortunately, techniques for ongoing management (e.g., placement, migration, expansion, collapse, etc.) of VMs as they are created and destroyed have not kept pace with the foregoing demands. What is needed are improved techniques for ongoing management of VMs in multi-node infrastructure settings. More specifically, what is needed is a technique or techniques that advance over legacy schedulers that are unaware of certain high-availability cluster configuration requirements.

### SUMMARY

This summary is provided to introduce a selection of concepts that are further described elsewhere in the written description and in the figures. This summary is not intended to identify key features or essential features of the claimed subject matter, nor is it intended to limit the scope of the claimed subject matter. Moreover, the individual embodiments of this disclosure each have several innovative aspects, no single one of which is solely responsible for any particular desirable attribute or end result.

The present disclosure describes techniques used in systems, methods, and computer program products for dynamic virtual machine scheduling in a high-availability infrastructure that supports virtual machine migrations, which techniques advance the relevant technologies to address technological issues with legacy approaches. More specifically, the present disclosure describes techniques used in systems, methods, and in computer program products that implement techniques for high-availability virtual machine placement across a plurality of computing nodes of a computing infrastructure. Certain embodiments are directed to technological solutions for implementation of high-availability (HA) placement engines that observe rules covering placement requirements for high-availability computing clusters.

The disclosed embodiments modify and improve over legacy approaches. In particular, the herein-disclosed techniques provide technical solutions that address the technical problems attendant to legacy schedulers that are unaware of certain high-availability placement requirements. Such technical solutions involve specific implementations (e.g., data organization, data communication paths, module-to-module interrelationships, etc.) that relate to the software arts for improving computer functionality. Various applications of the herein-disclosed improvements in computer functionality serve to reduce demand for computer memory, reduce demand for computer processing power, reduce network bandwidth usage, and reduce demand for intercomponent communication.

The ordered combination of steps of the embodiments serve in the context of practical applications that perform steps for implementation of placeholder-aware placement engines that observe rules covering placement requirements. The disclosed placeholder-aware placement engines (e.g., that observe rules covering placement requirements for high-availability computing clusters) overcome long-standing yet heretofore unsolved technological problems associated with legacy schedulers that are unaware of certain high-availability placement requirements that arise in the realm of high-availability computer systems.

Many of the herein-disclosed embodiments of placeholder-aware placement engines are technological solutions pertaining to technological problems that arise in the hardware and software arts that underlie high-availability computing systems. Aspects of the present disclosure achieve performance and other improvements in peripheral technical fields including, but not limited to, hyperconverged computing platform management and high-availability computing system configuration.

Some embodiments include a sequence of instructions that are stored on a non-transitory computer readable medium. Such a sequence of instructions, when stored in memory and executed by one or more processors, causes the one or more processors to perform a set of acts for implementation of placeholder-aware placement engines.

Some embodiments include the aforementioned sequence of instructions that are stored in a memory, which memory is interfaced to one or more processors such that the one or more processors can execute the sequence of instructions to cause the one or more processors to implement placeholder-aware placement engines.

In various embodiments, any combinations of any of the above can be organized to perform any variation of acts for calculating high-availability virtual machine placements across a plurality of computing nodes of a computing infrastructure, and many such combinations of aspects of the above elements are contemplated.

Further details of aspects, objectives and advantages of the technological embodiments are described herein and in the figures and claims.

### BRIEF DESCRIPTION OF THE DRAWINGS

The drawings described below are for illustration purposes only. The drawings are not intended to limit the scope of the present disclosure.

FIG. 1A1 is a flowchart that shows operations of a legacy scheduler that encounters a failure mechanism during migration.

FIG. 1A2 is a flowchart that shows example placeholder-aware placement engine operations that are able to complete a virtual machine migration without encountering the naive path failure mechanism of legacy schedulers, according to an embodiment.

FIG. 1B depicts an example virtualized cluster deployment wherein a placeholder-aware placement engine observes high-availability rules to identify an HA-compliant virtual machine placement, according to an embodiment.

FIG. 1C1, FIG. 1C2, FIG. 1C3, and FIG. 1C4 depict multiple views of an example multi-zone virtualized cluster deployment wherein a placeholder-aware placement engine observes high-availability rules to identify an HA-compliant virtual machine placement, according to one embodiment.

FIG. 1D depicts example placeholder placement rules, according to one embodiment.

FIG. 2A is a diagram that shows a naive scheduler that encounters an anti-affinity placement rule violation during migration.

FIG. 2B is a diagram that shows results of an improved placeholder-aware placement engine that is able to complete a virtual machine migration without violating an anti-affinity rule, according to an embodiment.

FIG. 3A is a flowchart that shows example operations of a legacy scheduler that miscalculates a high-availability failover resource amount during migration.

FIG. 3B is a flowchart that shows example operations of a placeholder-aware placement engine that correctly calculates a high-availability failover resource amount during migration.

FIG. 4 is a diagram showing an example fault-tolerant reboot-aware placement that results from invocation of a placeholder-aware placement engine.

FIG. 5 is a flowchart showing a cluster configuration using a high-availability rule aware scheduler, according to one embodiment.

FIG. 6A and FIG. 6B depict system components as arrangements of computing modules that are interconnected so as to implement certain of the herein-disclosed embodiments.

FIG. 7A, FIG. 7B, FIG. 7C, and FIG. 7D depict virtualization system architectures comprising collections of interconnected components suitable for implementing embodiments of the present disclosure and/or for use in the herein-described environments.

### DETAILED DESCRIPTION

Aspects of the present disclosure solve problems associated with using legacy schedulers that are unaware of certain high-availability placement requirements. These problems are unique to, and may have been created by deployment of legacy schedulers that are unaware of certain high-availability placement requirements in the context of high-availability computing systems. Some embodiments are directed to approaches for implementing placeholder-aware placement engines that observe rules covering placement requirements for high-availability computing clusters. Some embodiments are directed to techniques for establishing resource placeholders that are used to inform placement engines.

The accompanying figures and discussions herein present example environments, systems, methods, and computer program products that implement techniques for high-availability virtual machine placement across a plurality of computing nodes of a computing infrastructure.

### Overview

In many configurations of computing clusters that are built on top of multi-node computing infrastructure, virtualized componentry including virtual machines is supported. In such multi-node computing infrastructure settings, virtual machines are created and destroyed at a rapid pace, thus causing rapidly changing computing infrastructure usage. For example, at one moment in time there might be only a few virtual machines running on a cluster, whereas at a next moment in time there might be hundreds or thousands of virtual machine running on the same cluster. Accordingly, this leads to the need for a high-performance virtual machine monitor/supervisor that can accommodate the correspondingly fast-paced changes to computing resource utilization (e.g., CPU and memory utilization) as virtual machine are created and destroyed.

Moreover, consistent with constantly increasing demands for 99.99999 (five nines) availability, the foregoing high-performance virtual machine monitor/supervisor must consider the impact to the cluster's high-availability requirements (e.g., fast restoration requirements, maximum data loss requirements etc.) when making monitoring and or supervisory decisions. More specifically, such a monitor/supervisor might be called at any moment in time so as to analyze the infrastructure and decide to migrate one or more VMs for any of a panoply of reasons (e.g., so as to implement cluster defragmentation, so as to mitigate a computing infrastructure hotspot, so as to migrate a VM to comply with licensing issues, so as to migrate a VM to comply with security issues or merely to respond to a user's request to migrate a VM, etc.), and in doing so, the monitor/supervisor might require that any configuration of VMs that are running on nodes of the cluster are configured in a manner that observes high-availability requirements. Further, such a monitor/supervisor might be called at any moment in time so as to implement a virtual entity migration plan that achieves a configuration that satisfies a particular metric for fast recovery, and/or a particular metric for low or zero data loss, etc.

Unfortunately, legacy techniques exhibit many deficiencies when dealing with such metrics. Strictly as one example of such a deficiency, when a legacy monitor/supervisor begins to migrate a virtual machine from a source node to a target node, it can happen that some other process (e.g., a process other than the monitor/supervisor) might consume so many resources at the target node that the migration must be aborted since there are insufficient resources available at the target node, thus preventing completion of the migration. This situation and other situations like it are to be strongly avoided. One way to avoid having to abort a migration would be to implement a monitor/supervisor that is (1) aware of rules governing redundancy, recoverability and other metrics that pertain to high availability; (2) is able to reserve resources in advance of beginning a migration; and (3) is able to honor reserved resources that had been earmarked by other processes.

### Feature #1: Pre-Migration Resource Reservation

In one implementation, a monitor/supervisor and/or any of its constituent or subordinate processes (e.g., VM state supervisory processes, migration processes, garbage collection processes, etc.) can be controlled by hypervisors running on the source and the destination nodes. Specifically, before the migration from one node to another node starts, one of the hypervisors (e.g., the hypervisor on the destination node) reserves sufficient resources (e.g., using a placeholder reservation) to accept the incoming VM. Once the VM is successfully and fully migrated to the target cluster, the resources that had been in use on the source node are freed and the placeholder reservation is converted into an actual resource allocation. If it turns out that the migration fails (e.g., due to myriad reasons), the placeholder is deleted.

### Feature #2: Scheduler Resource Reservation Awareness During Ongoing Resource Utilization Optimization

It should be noted that virtual machine migration often involves many concurrently running processes-some of which are long running processes that may run for many seconds to many minutes. Accordingly, a dynamic scheduler that aids resource usage optimization may be called repeatedly and at any time. More specifically, a dynamic scheduler may be called repeatedly (e.g., so as to perform additional resource usage improvements) during the timeframe when some virtual machines are migrating.

### Feature #3: Hypervisor Resource Reservation Awareness

A naive scheduler that is not aware of resource reservations/placeholders might naively/wrongly consider certain resources to be available and take actions (e.g., to request allocations) to use them, for instance, for a purpose other than the intended virtual machine migration. However such actions (e.g., to request allocations) would be denied by the hypervisor. Even in the situation where the scheduler is configured to attempt recovery from such an error (e.g., resource allocation denial by the hypervisor), it can happen that when the scheduler again attempts to request resources needed to perform the VM migration, the resource allocation requests might again be denied by the hypervisor of the target node, thus leading to a scheduling issue that cannot necessarily be resolved by the scheduler. As such, hypervisors in accordance with the herein-disclosed techniques are configured to be resource reservation aware.

### Feature #4: VM Pinning During Migration

Placeholder-aware schedulers pin migrating VMs so as to avoid double-migrations (e.g., when a source VM is being migrated and the scheduler seeks a further move of the being-migrated VM). Pinned VM awareness can be implemented in a scheduler, while at the same time reservation placeholder-aware schedulers are configured to consider such resource reservation placeholders so as to avoid resource stealing.

### Feature #5: Anti-Affinity Rule Awareness of Resource Reservations

Some virtualization system implementations support VM placement rules or constraints that are intended to avoid placement of certain pluralities of virtual machines on the same node. For example, if a database VM were placed on a first node, then when placing a database health monitor VM, an anti-affinity rule might require that the database health monitor be placed on a different node than the database VM. Virtualization systems involving schedulers that are aware of anti-affinity rules operate (or at least attempt) to place all involved/related VMs on different nodes. As used herein, an anti-affinity rule carries the semantics that cause a scheduler or placement engine to attempt to place different VMs on different nodes, for example, in a manner such that no two user VMs are placed on the same computing node. As further discussed herein, if resource reservation placeholders are not considered (e.g., by a naive scheduler) the scheduler may unwittingly cause an anti-affinity rule/constraint violation where two or more VMs will end up being unwantedly collocated on the same node. In some deployments, observance of any number of anti-affinity rules/constraints is critical to achievement of a service resiliency guarantees. In some deployments, any number of placement rules are configured to consider placeholders when a subject VM is subject to a VM-to-VM anti-affinity regime.

### Feature #6: VM Reboot Rule Awareness of Resource Reservations in or Across Availability Zones

An availability zone is a group of nodes that has some property or properties in terms of resiliency to hardware failure. Fault tolerance of a computing cluster is sometimes characterized by a numeric value that represents the number of node failures that can be tolerated without experiencing downtime in the cluster. A numeric value can be assigned to a fault tolerance variable FT. Strictly as an example, if a cluster's availability is characterized by node loss fault tolerance equal to 1 (FT=1), then in case of any single node failure in the availability zone, it is possible to reboot/restart the VMs that were running on the failed node. More specifically, the VMs that were running on the failed node can be redeployed among the remaining nodes (i.e., non-failed nodes) in the availability zone and then rebooted/restarted immediately (e.g., without having to migrate running VMs before commencing the reboot/restart).

When migrating a VM to a node within a given availability zone, the VM and any resource reservation placeholders that are within the given availability zones must be considered. When migrating a VM from a node from within a given availability zone to a different node in a different availability zone, double-counting of the placeholder must be avoided since even a temporary double counting could lead to a reduction of the cluster's hosting capacity. More specifically, and to illustrate, if a resource reservation placeholder is considered for a migration within an availability zone, this leads to a reduction of the cluster capacity. However, if it is not considered for a migration between availability zones, this may break the high-availability promise of being able to reboot all of the lost VMs.

### Feature #7: Real-Time Migration Parameter Publication

A virtualization system can be configured to publish all ongoing migration processes such that the existence of the resource reservation placeholders is published or otherwise made available to the scheduler.

### Feature #8: Position-Independent Rule Semantics

Any of the foregoing rules can be defined with semantics that are agnostic to where the rule is being enforced. In fact, rules can be idempotent such that a second application of a rule after a first application of the same rule will produce the same result as did the first application of the rule.

Feature #9: Rule Semantics to Observe HA Reboot Constraints within Availability Zones

Certain scheduling rules consider high-availability reboot rules in a fault tolerant cluster. More particularly, certain scheduling techniques consider intra-zone VM placements in order to observe reboot requirements or constraints. Observance of intra-zone VM placements to observe reboot requirements serves to increase the likelihood that a HA guarantee will be indeed achieved in case of a failure.

### Feature #10: Rule Semantics to Observe Availability Zone-Specific Placeholder Resource Usage

Certain scheduling rules consider the placeholder resource usage within availability zones in order to observe a plurality of high-availability placement rules.

### Definitions and Use of Figures

Some of the terms used in this description are defined below for easy reference. The presented terms and their respective definitions are not rigidly restricted to these definitions-a term may be further defined by the term's use within this disclosure. The term “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion. As used in this application and the appended claims, the term “or” is intended to mean an inclusive “or” rather than an exclusive “or”. That is, unless specified otherwise, or is clear from the context, “X employs A or B” is intended to mean any of the natural inclusive permutations. That is, if X employs A, X employs B, or X employs both A and B, then “X employs A or B” is satisfied under any of the foregoing instances. As used herein, at least one of A or B means at least one of A, or at least one of B, or at least one of both A and B. In other words, this phrase is disjunctive. The articles “a” and “an” as used in this application and the appended claims should generally be construed to mean “one or more” unless specified otherwise or is clear from the context to be directed to a singular form.

Various embodiments are described herein with reference to the figures. It should be noted that the figures are not necessarily drawn to scale, and that elements of similar structures or functions are sometimes represented by like reference characters throughout the figures. It should also be noted that the figures are only intended to facilitate the description of the disclosed embodiments-they are not representative of an exhaustive treatment of all possible embodiments, and they are not intended to impute any limitation as to the scope of the claims. In addition, an illustrated embodiment need not portray all aspects or advantages of usage in any particular environment.

An aspect or an advantage described in conjunction with a particular embodiment is not necessarily limited to that embodiment and can be practiced in any other embodiments even if not so illustrated. References throughout this specification to “some embodiments” or “other embodiments” refer to a particular feature, structure, material, or characteristic described in connection with the embodiments as being included in at least one embodiment. Thus, the appearance of the phrases “in some embodiments” or “in other embodiments” in various places throughout this specification are not necessarily referring to the same embodiment or embodiments. The disclosed embodiments are not intended to be limiting of the claims.

### Descriptions of Example Embodiments

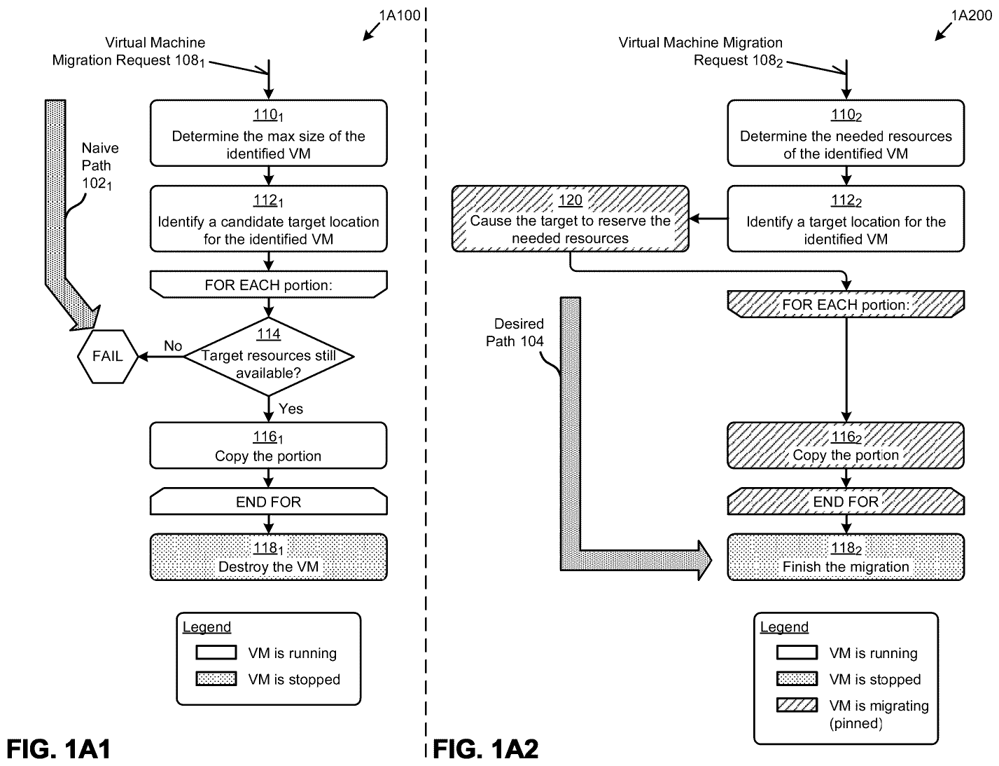

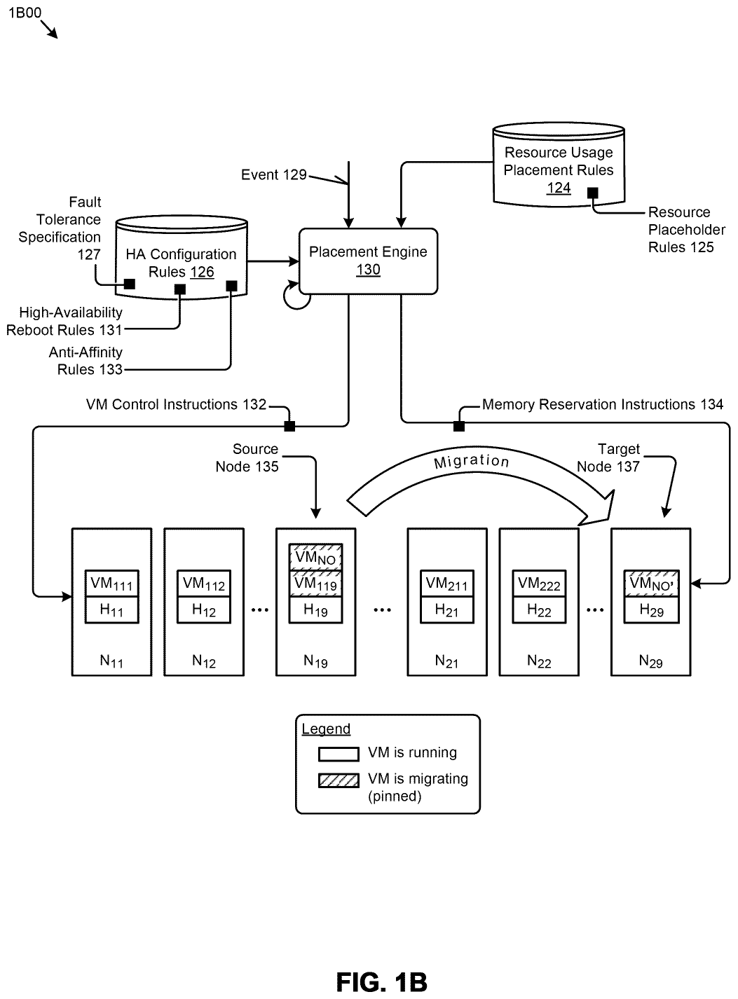

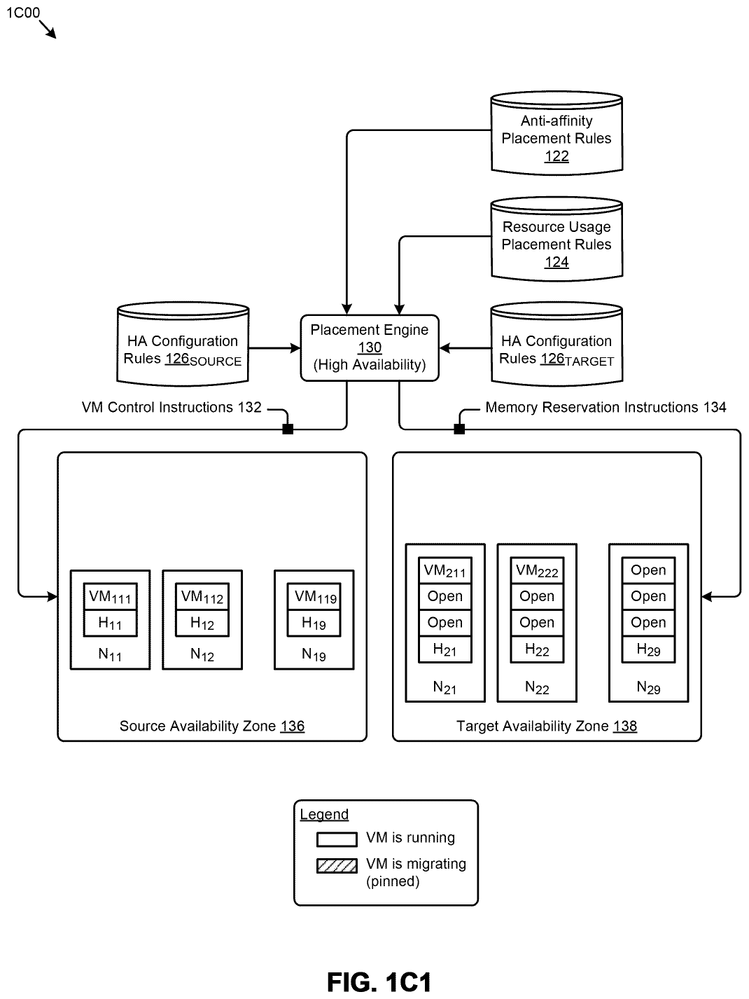

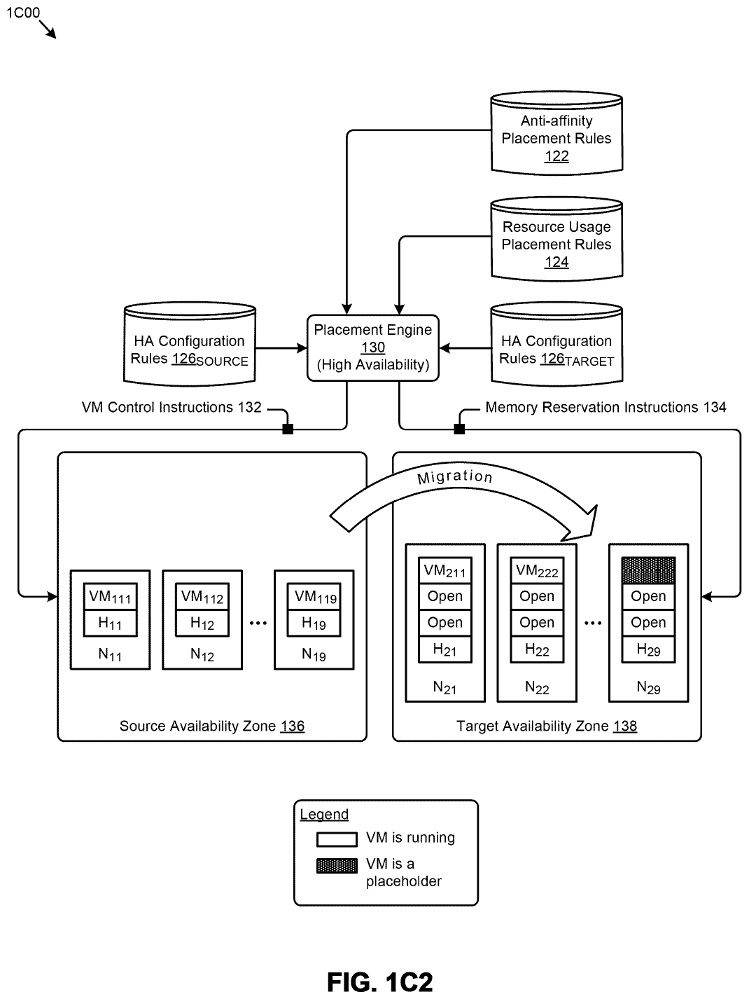

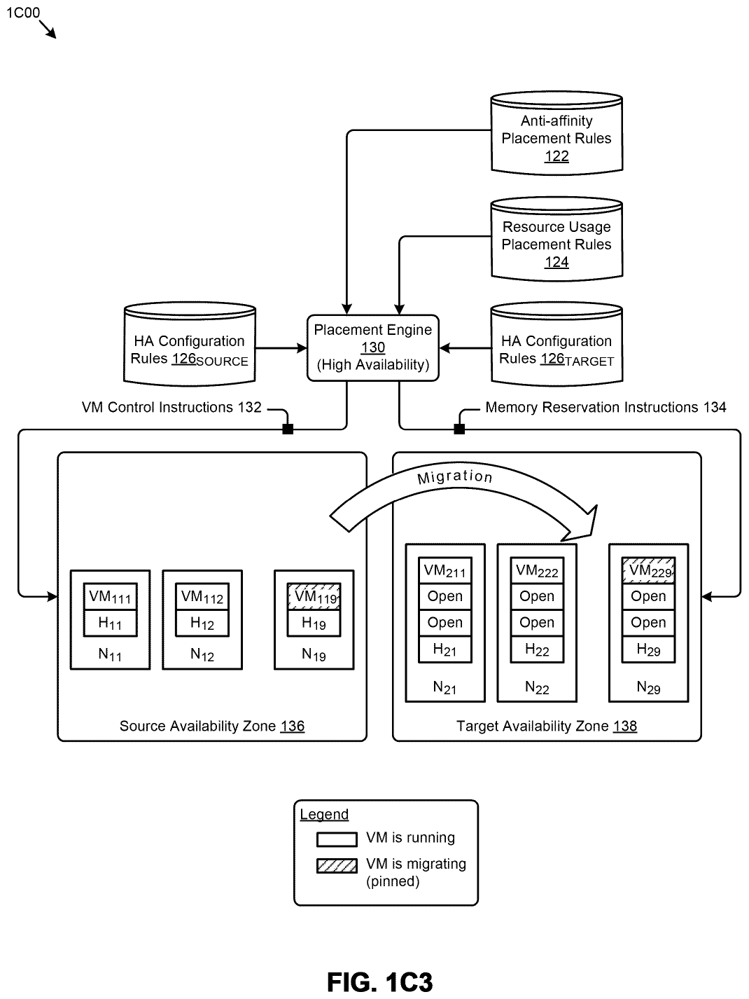

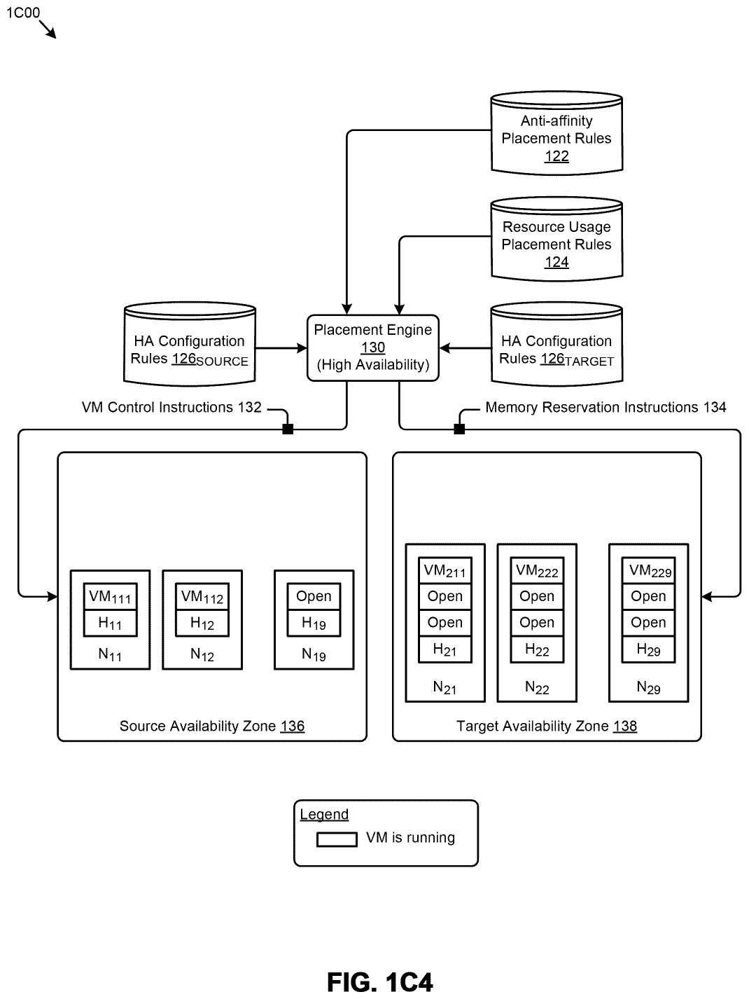

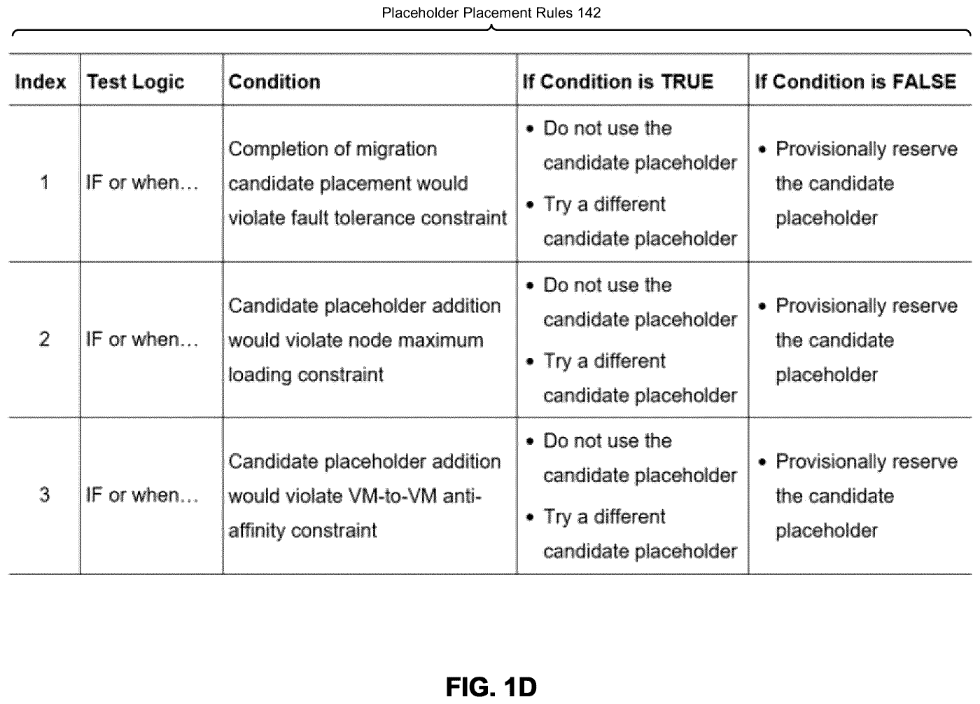

FIG. 1A1 is a flowchart that shows operations of a legacy scheduler that encounters a failure mechanism during migration. As an option, one or more variations of legacy scheduler operations 1A100 or any aspect thereof may be implemented in the context of the architecture and functionality of the embodiments described herein and/or in any environment.

The figure is being presented to illustrate the need to improve over legacy schedulers that are unaware of reservation placeholders. More specifically, the figure is being presented to illustrate deficiencies in legacy schedulers that can be addressed by the herein-disclosed techniques.

The flow of the example legacy migration technique shown in FIG. 1A1 commences upon receipt of a virtual machine migration request 108₁ to migrate a particular virtual machine (VM). This migration request invokes a process to determine the maximum size of the VM (step 110₁). This is because the next step is to (1) identify a target location (e.g., a target node) for the identified VM (step 112₁), and (2) because it needs to be known that there are sufficient resources available at a candidate target host. Selection of a candidate target host (e.g., a target node) can be accomplished using any known technique.

Once a target host has been selected, the flow proceeds to copy the VM to the determined target host. To do this, the virtual memory of the particular VM to be migrated is divided into portions (e.g., memory pages) such that after a series of portions have been copied over to the target host (e.g., in a FOR EACH loop), the VM at the target host will be deemed to be ready to run. The VM running at the source location can then be stopped and destroyed (step 118₁) or otherwise dealt with so as to relinquish the resources that were in use by the VM running at the source location.

In some cases, a VM migration requires that a to-be-migrated VM be temporarily quiesced. In other cases, copying of a to-be-migrated VM can be accomplished even while the to-be-migrated VM is running at its source location.

Assuming that the identification of a target location (e.g., via step 112₁) did indeed identify a target host that was deemed to have enough resources to host the to-be-migrated VM, each portion of the to-be-migrated VM can be copied to the target host portion by portion (step 116₁) in a FOR EACH loop.

Unfortunately, this flow of the shown legacy scheduler operations 1A100 can end in failure at decision 114 if/when the candidate target host indicates that there are insufficient memory resources available. This can happen if the candidate target host is a node that is running additional processes, which additional processes demand memory resources, and which additional processes demand memory resources in a manner that allocates memory previously deemed to be available for holding code or data of the to-be-migrated VM.

When this is the case (i.e., when, at decision 114, the target host indicates that there are insufficient memory resources available even after the target host was deemed to have sufficient resources), it can happen that the naive path 102₁ ends in a failure condition. When this happens, the then-current migration fails, and the scheduler is called again to try again. The second try might succeed, or the second try might fail again. Unless some conditions change, a third or Nth attempt is no more likely to succeed than any previous attempt. Moreover, when this or similar situations occur (e.g., when, at decision 114, the candidate target host indicates that there are insufficient memory resources available even after the candidate target host was earlier deemed to have sufficient resources), the impact on the computing cluster can be dire or at least present extreme risk to the cluster's health. Strictly as one example, consider the situation when a high-availability regime is in force. In such a situation, the to-be-migrated VM might need to be migrated in order to comport with whatever high-availability specifications (e.g., a failure tolerance requirement) are in force. Improved techniques are needed.

A legacy scheduler such as comprehended in the foregoing can be improved by implementation of a constraint-aware placement regime that requires pre-allocation of virtual machine resources (e.g., CPU capability/headroom, memory, storage areas, etc.) in advance of the migration. Such pre-allocation (sometimes referred to as “pre-booking”) can be implemented as a series of operations that are embodied in a placeholder-aware placement engine. One example of such a series of operations is shown and described as pertains to the flowchart of FIG. 1A2.

FIG. 1A2 is a flowchart that shows example placeholder-aware placement engine operations that are able to complete a virtual machine migration without encountering the naive path failure mechanism of legacy schedulers. As an option, one or more variations of placeholder-aware placement engine operations 1A200 or any aspect thereof may be implemented in the context of the architecture and functionality of the embodiments described herein and/or in any environment.

The figure is being presented to illustrate how a pre-allocation or pre-booking of virtual machine resources (e.g., CPU capability/headroom, memory, storage areas, etc.) in advance of the migration can increase the likelihood that the migration will be able to complete even in the presence of many resource-demanding processes (e.g., hypervisors, schedulers, etc.) at the target location.

The placeholder-aware placement engine operations 1A200 of FIG. 1A2 differs from the legacy scheduler operations 1A100 of FIG. 1A1 at least in that there is no decision (e.g., decision 114 of FIG. 1A1) to determine if the needed target resources are still available. This is because the placeholder-aware placement engine operations 1A200 causes the target to reserve the needed resources (step 120) for migrating a VM to a target location. Consequently the desired path 104 is taken which leads to finishing the migration without incurring a “No MEMORY” or similar resource unavailability error.

More specifically, in the shown flow, step 120 is reached responsive to identification of a target location for the identified VM (step 112₂) which is dependent upon, at least in part, a determination that there are a sufficiency of the needed resources (step 110₂) which, in turn, is responsive to receiving a request to migrate the particular VM (e.g., virtual machine migration request 108₂).

Having caused the target to actually pre-allocate or pre-book the needed resources (step 120), then a FOR EACH loop is entered to copy portions of the memory contents (e.g., at step 116₂) of the to-be-migrated VM from the source to the target. During this time, specifically, during iterations through the loop, the to-be-migrated VM is placed into a state termed “migrating.” When a VM is in this state termed “migrating,” it might be stopped (e.g., in a quiesced migration scenario), or it might be running (e.g., in a so called “live migration” scenario); however in either case, any agent at the source location and any agent at the target location can know that the VM is in this “migrating state.” As is discussed in detail hereunder, many decisions that affect the course of migration of the VM can depend on knowledge that the to-be-migrated VM is in a “migrating state.”

When the VM migration is complete (e.g., upon exit of the FOR EACH loop), the migration can be finished (step 118₂), possibly including destroying the VM at its source location.

One, or some, or all of the foregoing placeholder-aware placement engine operations 1A200 can be carried out by any operational element within virtualized cluster deployment. An example of such a virtualized cluster deployment is shown and described as pertains to FIG. 1B.

FIG. 1B depicts an example virtualized cluster deployment wherein a placeholder-aware placement engine observes high-availability rules to identify an HA-compliant virtual machine placement. As an option, one or more variations of virtualized cluster deployment 1B00 or any aspect thereof may be implemented in the context of the architecture and functionality of the embodiments described herein and/or in any environment.

The figure is being presented to illustrate one way that node-specific hypervisors and a placement engine 130 can be configured to be able to observe high-availability rules in order to progress through an HA-compliant virtual machine placement.

As shown, a placement engine 130 is informed by a set of HA configuration rules 126 and a set of resource usage placement rules 124. The HA configuration rules may include a fault tolerance specification 127 and any number of high-availability rules (e.g., any number of anti-affinity rules 133 and/or any number of high-availability reboot rules 131, etc.). Additionally or alternatively, resource usage placement rules 124 may include resource placeholder rule 125 and/or any number or type of high-availability rules. These rulebases (i.e., a repository of logical statements) may be consulted at any time by the placeholder-aware placement engine. In particular these rulebases may be consulted by the placeholder-aware placement engine upon receiving an event 129. Such an event might correspond to a migration request, or such an event might correspond to a change to any of the rulebases.

Consider the array of nodes (e.g., node N₁₁; node N₁₂, . . . , node N₁₉; node N₂₁; node N₂₂, . . . , node N₂₉) where each node hosts its corresponding hypervisor (e.g., hypervisor H₁₁; hypervisor H₁₂, . . . , hypervisor H₁₉; hypervisor H₂₁; hypervisor H₂₂, . . . , hypervisor H₂₉) as well as one or more corresponding VMs (e.g., virtual machine VM₁₁₁; virtual machine VM₁₁₂, . . . , virtual machine VM₁₁₉; . . . virtual machine VM_{NO}, . . . , virtual machine VM₂₁₁; and virtual machine VM₂₂₂ . . . , VM_{NO′}). At an initial point in time=T0, node N₁₉ hosts two VMs, whereas node N₂₉ host no VMs. This exemplifies a load balancing opportunity. Furthermore, in the case where there are HA rules in place and/or in the case where there are anti-affinity rules 133 in force, the configuration at time=T0 might violate such rules. As such, there exists one or more reasons for the second VM at source node 135 of the computing cluster to be migrated to target node 137 of the computing cluster. A placeholder-aware placement engine can respond to a migration request for the VM at the source node 135 (e.g., the shown VM_{NO}) of the computing cluster to be migrated to the target node 137 of the computing cluster (e.g., to create virtual machine VM_{NO′})

More specifically, the placeholder-aware placement engine can consider any then-in-force rules (e.g., HA rules, placement rules, other rules, etc.) so as to generate VM control instructions 132 and memory reservation instructions 134. These instructions are received by the computing cluster and applied at the subject nodes (e.g., node N₁₉ and node N₂₉). The VM control instructions might include instructions as to whether or not and how a VM at the source node is to be migrated (e.g., in a quiesced state, or using a live migration technique, etc.). The memory reservation instructions might include specifics on whether or not and how a particular type of resource is to be pre-allocated. In exemplary embodiments, the VM control instructions specify and/or interpret memory reservation instructions in a manner such that once the migration has completed, all of the then in-force and applicable rules are satisfied. In some situations, the VM control instructions specify and/or interpret memory reservation instructions in a manner such that a migration scheduling remediation protocol is observed.

The foregoing written description pertains to merely one possible embodiment and/or way to implement a virtualized cluster deployment, and many variations are possible. For example, the virtualized cluster deployment as comprehended in the foregoing can be implemented in conjunction with a migration scheduling remediation protocol.

FIG. 1C1 depicts an example multi-zone virtualized cluster deployment wherein a placeholder-aware placement engine observes high-availability rules to identify an HA-compliant virtual machine placement. As an option, one or more variations of virtualized cluster deployment 1C00 or any aspect thereof may be implemented in the context of the architecture and functionality of the embodiments described herein and/or in any environment.

The figure is being presented to illustrate how node-specific hypervisors and a placement engine 130 can be configured to be able to observe a panoply of rules (e.g., anti-affinity placement rules 122, resource usage placement rules 124, and high-availability rules) to identify an HA-compliant virtual machine placement that is constrained by rules that apply to specific two or more availability zones.

As shown, the foregoing HA configuration rules 126 (see FIG. 1B) are now bifurcated into a first set of HA configuration rules (e.g., HA configuration rules 126_{SOURCE}) that apply to a first availability zone and a second set of HA configuration rules (e.g., HA configuration rules 126_{TARGET}) that apply to a second availability zone. In this bifurcated manner, the source and target rules can be different so as to accommodate differences in the plurality of availability zones (e.g., source availability zone 136 and target availability zone 138). Strictly as one example, a first availability zone might be configured with an HA rule corresponding to the semantics of, “Fault Tolerance=1,” whereas a second availability zone might be configured with an HA rule corresponding to the semantics of, “Fault Tolerance=2.”

In addition to the bifurcated HA configuration rules, the multi-zone virtualized cluster deployment of FIG. 1C1 might include or provide access to a repository of anti-affinity placement rules. A particular anti-affinity placement rule might specify that no two VMs should be placed on the same node. Or, a particular anti-affinity placement rule might specify that a maximum of two VMs can be hosted on any given node. Or, as yet another example, a particular anti-affinity placement rule might specify that no two VMs of the same type can be hosted on any given node.

As used herein, a virtualized high-availability multi-node computing cluster is a collection of independent computing nodes that are configured to run virtual machines, wherein the virtual machines are placed across nodes in a manner that achieves a particular degree of fault tolerance. A particular degree of fault tolerance can be expressed as a numeric value (e.g., 1, or 2, or 3, etc.) where the numeric value corresponds to the number of nodes of the cluster that can become unavailable, yet without loss of functionality of the cluster as a whole, even though cluster performance may be degraded. Additionally or alternatively, particular degree of fault tolerance can be implemented via defining a plurality of availability zones where each of the plurality of availability zones host respective computing clusters, each of which of the respective computing clusters has sufficient computing resources to run (1) all of the VMs assigned to a particular availability zone, plus (2) at least one additional VM from a different availability zone. To further explain, consider a first availability zone running a first set of VMs on a first respective computing cluster. Now consider a second availability zone running a second set of VMs on a second respective computing cluster (e.g., a failover cluster). For high availability, the resources of the first availability zone are configured to be sufficient to run the first set of VMS as well as the second set of VMs (e.g., in case of failure of one or more nodes of the second availability zone, or in case of unavailability of the second availability zone). Similarly, for high availability, the resources of the second availability zone are configured to be sufficient to run its own second set of VMS as well as the first set of VMs (e.g., in case of failure of one or more nodes of the first availability zone, or in case of unavailability of the second availability zone). In a simple situation, consider the case where the first set of VMs comprises only one VM. In this situation, the second availability zone is configured to have sufficient computing resources to run (1) all of the VMs assigned to the second availability zone, plus (2) the one additional VM from the first availability zone. The configurations as heretofore expressed can be codified by one or more high-availability configuration rules.

As used herein, high-availability configuration rules are codifications of conditions that are to be present in the computing cluster so as to facilitate computing system recovery from an event that causes loss of some functionality of the computing cluster. High-availability configuration rules may refer to colocation placement requirements (or anti-colocation or anti-affinity placement requirements), and/or high-availability configuration rules may refer to virtual machine reboot capability requirements, and/or high-availability configuration rules may refer to placement requirements for VMs to be correlated to availability zones and/or otherwise placeable or migratable to/from particular availability zones.

As shown in FIG. 1C1, and more specifically, referring to the boundaries of two availability zones (e.g., source availability zone 136 and target availability zone 138), both of the two availability zones have three nodes. As shown, source availability zone 136 has three VMs running (virtual machine VM₁₁₁, virtual machine VM₁₁₂, and virtual machine VM₁₁₉), each of which consume virtually all of the resources of each VM's respective host node. In this configuration, target availability zone 138 is not HA compliant, given an HA rule corresponding to the semantics of, “Fault Tolerance=1.” At some point in time (e.g., when the HA rule corresponding to the semantics of, “Fault Tolerance=1” is assigned to the target availability zone), an instance of a placement engine 130 (or its agents) will notice that source availability zone 136 is not in compliance with the set of assigned HA rules. Specifically, there are not enough free resources (e.g., open slots) to accommodate a single node failure. This is because there are not enough available resources in the availability zone to restart the VM of the failed node. One way to remediate this would be to free up resources within source availability zone 136, and one way to do that is to migrate virtual machine VM₁₁₉ to a different available zone (e.g., to target availability zone 138).

A migration operation is shown and described as pertains to FIG. 1C2. Specifically, the shown migration operation moves VM₁₁₉ from node N₁₉ of source availability zone 136 to an open slot in node N₂₉ of target availability zone 138. At the beginning of this migration operation, the source VM (VM₁₁₉) is running and the intended target location is reserved using a placeholder. Instancing a placeholder, and observance of the semantics of the placeholder (e.g., by the scheduler and/or its agents) ensures that the reserved resources corresponding to the placeholder on node N₂₉ will not be consumed by other operations carried out on or involving node N₂₉. After instancing the placeholder, the migration can continue. Specifically, data and code comprising the VM can be copied from node N₁₉ to node N₂₉.

This is shown and described as pertains to FIG. 1C3. Specifically, the figure shows that during migration, any amount of data and code comprising VM₁₁₉ as well as any amount of data and code comprising migrated virtual machine VM₂₂₉ are pinned (i.e., do not swap out to lower-tier memory). Ongoing operations that might occur while the data and code are being migrated can take any amount of time, during which time the other virtual machines (and hypervisors) on node N₂₁ and node N₂₂ can execute. When the last of the code and data of virtual machine VM₁₁₉ have been migrated, virtual machine VM₁₁₉ can be destroyed. At the same time that the code and data of virtual machine VM₁₁₉ is being migrated, migrated (or migrating) virtual machine VM₂₂₉ is capable executing from the portions of the code and corresponding data that has been migrated. In various embodiments, one or more means for cutover is provided, including cutover to the partially migrated (e.g. in migration) VM even before all the code and data of the subject VM has been migrated from source to target.

Further details regarding general approaches to migrating code and data of a virtual machine are described in U.S. patent application Ser. No. 17/710,342 titled “VIRTUAL MACHINE REMOTE HOST MEMORY ACCESSES” filed on Mar. 31, 2022, and in U.S. Pat. No. 11,188,368 titled “ASYNCHRONOUS WORKLOAD MIGRATION CONTROL” issued on Nov. 30, 2021, both of which are hereby incorporated by reference in their entirety.

FIG. 1C4 depicts the state after the migration has been completed. As can now be seen, the configuration of source availability zone 136 is now FT=1 compliant since, in the event of failure of any node within source availability zone 136, there remain sufficient available resources in the non-failed nodes such that all of the VMs that were running on the failed node can be restarted with the available resources within that availability zone. Also, as can now be understood, the configuration of target availability zone 138 is FT=2 compliant since, in the event of failure of any two nodes within target availability zone 138, there remain sufficient available resources in the non-failed nodes such that all of the VMs that were running on the failed one or two nodes can be restarted using the available resources within that availability zone.

The foregoing are merely example scenarios having respective constraints, rules and conditions. Other scenarios are possible, each of which might correspond to a particular condition or set of conditions which, when considered in the course of a VM migration, might invoke one or more placement rules. A set of example placeholder placement rules are shown and described as pertains to FIG. 1D.

FIG. 1D depicts example placeholder placement rules. Any aspect thereof may be implemented in the context of the architecture and functionality of the embodiments described herein and/or in any environment.

A scheduler or placement engine that uses high-availability rules and/or placeholder placement rules) exhibits improved results as compared to legacy schedulers. More specifically, the VM placements that result from using placeholder placement rules 142 improves over legacy schedulers at least in the sense that placeholder rules are considered when migrating a VM. Merely for illustrative purposes, a set of placeholder placement rules is being depicted as a table. Each row in the table includes a description of an index, a test that defines an IF or WHEN scenario, a condition corresponding the given test, and a set of conditional actions that are carried out based on whether the condition is deemed to be TRUE or FALSE.

One possible resource placeholder rule might pertain to fault tolerance requirements or constraints that need to be observed during VM migration. As another example, a resource placeholder rule might pertain to maximum loading constraints that need to be observed during VM migration. As yet another example, a resource placeholder rule might pertain to the anti-affinity of VMs that need to be observed during VM migration. These and/or any number of other placeholder rules can be considered in the context of a constraint-aware placement regime that, at least in part, relies on the ability to implement resource placeholders. Such a constraint-aware placement regime involving resource placeholders improves over legacy or naive schedulers. Moreover, enforcement of a constraint-aware placement regime involving resource placeholders yields improved predictability and an increased likelihood that any then-currently in-force high-availability rules can be addressed when migrating VMs.

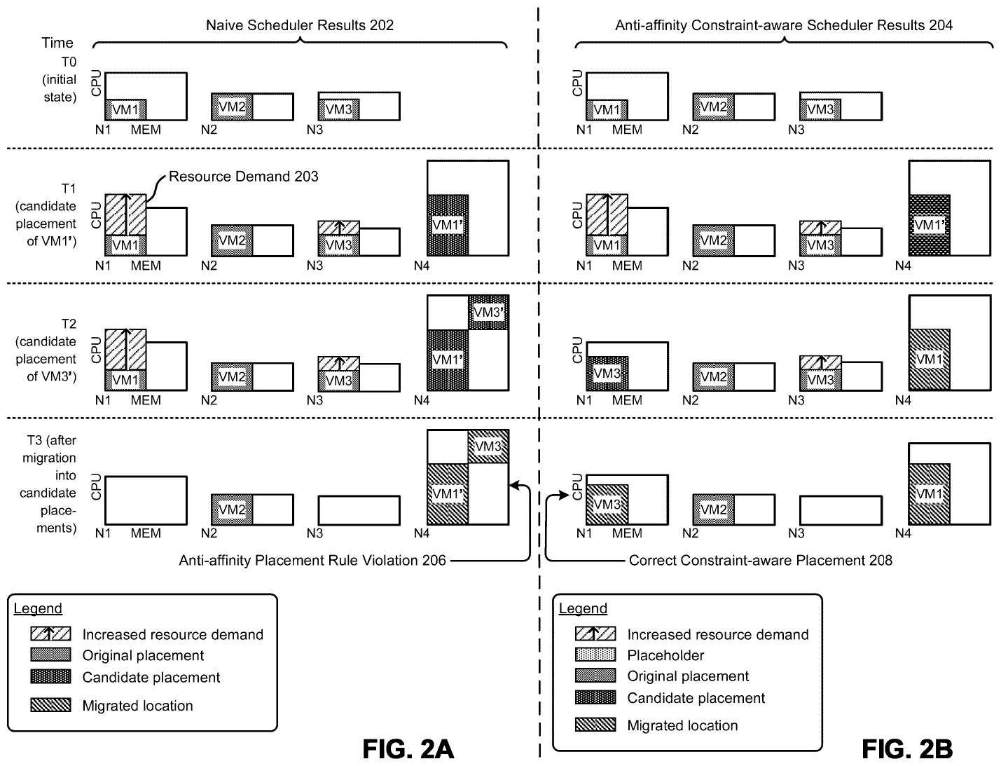

FIG. 2A is a diagram that shows a naive scheduler that encounters an anti-affinity placement rule violation during migration. As an option, one or more variations of naive scheduler or any aspect thereof may be implemented in the context of the architecture and functionality of the embodiments described herein and/or in any environment.

FIG. 2B is a diagram that shows results of an improved placeholder-aware placement engine that is able to complete a virtual machine migration without violating an anti-affinity rule, according to an embodiment. As an option, one or more variations of improved placeholder-aware placement engine or any aspect thereof may be implemented in the context of the architecture and functionality of the embodiments described herein and/or in any environment.

FIG. 2A and FIG. 2B are being presented on the same sheet so as to illustrate differences in placement results of a naive placement versus a placeholder-aware placement that considers an anti-affinity rule. As used herein, an anti-affinity rule refers to a conditional test of the placement of virtual machines such that placement of multiple VMs on the same node is to be avoided.

As shown in FIG. 2A, a naive scheduler might handle a VM migration in a manner such that, although the VMs of the cluster can run after migration, the node that hosts the target migration location also hosts a different VM. This condition, shown under the naive scheduler results 202 as corresponding to time=T3, is indicative of an anti-affinity rule violation, specifically anti-affinity placement rule violation 206. At least inasmuch as pertains to anti-affinity awareness, the shown anti-affinity placement rule violation 206 can be remediated such that anti-affinity rules can be considered and honored.

To further explain, note that at time=T0 (initial state) there are three nodes: node N1, node N2, and node N3 that host a respective three VMs: VM1, VM2, and VM3. Now, at time=T1, VM1 raises resource demand 203 for more CPU resources than are available on node N1, therefore VM1 needs to be moved. One considered (but infeasible) candidate placement of VM1 is to put it on node N2, however there are not enough CPU resources on node N2 to do so. Another considered (but infeasible) candidate placement of VM1 is to put it on node N3, however there are not enough CPU resources on node N3 either. Accordingly, a new node, node N4, is allocated so that VM1 can be migrated (to newly allocated node N4).

Further consider that at time=T1 or at a subsequent time T2, VM3 on node N3 demands more CPU resources than are available on node N3. The naive scheduler is unaware that resized VM3 could be moved onto node N1. Also, the resized VM3 cannot be moved onto node N2 since VM3 requires more CPU resources than are available on node N2, so the naive scheduler moves VM3 onto node N4. Unfortunately, use of a naive placement scheduler in this scenario results in an anti-affinity placement rule violation 206 at time=T3 because the anti-affinity constraint forbidding placement of two or more VMs on the same node has been violated by the situation of placing both VM1′ and VM3′ on node N4.

One possible technique for remediation is to use a placement engine that is aware of a VM's migrating state and proposed placement maneuvers so as to generate an anti-affinity constraint-aware placement such as is shown and described as pertains to FIG. 2B.

At time=T3 of the shown anti-affinity constraint aware scheduler results 204, there is at most one VM running on any given node of the cluster. This is depicted as correct constraint-aware placement 208. This is to be contrasted with the anti-affinity placement rule violation 206 of FIG. 2A, where node N4 is hosting two VMs.

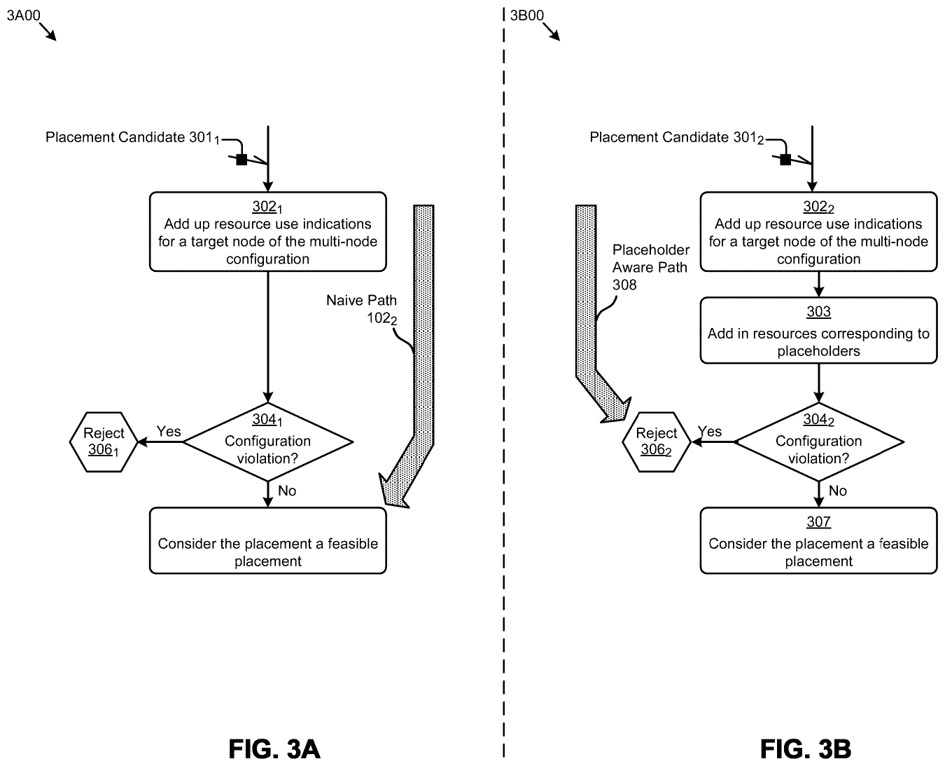

The foregoing focusses on merely one aspect of a migration-aware system, specifically a migration-aware system that considers anti-affinity rules. In addition to the fact that there are many variations of anti-affinity rules, many other placement rules or constraints are possible, any or all of which can be observed by a migration-aware system. For example, the improved migration-aware placement system as comprehended in the foregoing can implement anti-affinity rules in conjunction with (or independent of) other configuration rules. Moreover, a migration-aware placement system can be configured to be able to concurrently honor any one or more sets of rules or constraints that might be drawn from any one or more rulebases. The operations of such a migration-aware placement system is to be distinguished from how legacy schedulers operate. The following FIG. 3A and FIG. 3B are presented on the same sheet so as to highlight distinguishing features.

FIG. 3A is a flowchart 3A00 that shows example operations of a legacy scheduler that miscalculates a high-availability failover resource amount during migration. FIG. 3A is to be compared with FIG. 3B, which is a flowchart 3B00 that shows example operations of a placeholder-aware placement engine that correctly calculates a high-availability failover resource amount during migration.

FIG. 3A and FIG. 3B are being presented on the same sheet to illustrate how operations of a legacy scheduler might differ from operations of a placeholder-aware scheduler. Specifically, and as shown, a naive scheduler (e.g., a placeholder-unaware scheduler) might add up resource use indications that apply to a particular node and, on the basis of that calculation, the naive scheduler of FIG. 3A might deem that the node has sufficient resources to be able to comport with high-availability configurations. This is to be contrasted with results from the placeholder-aware scheduler of FIG. 3B, in that the placeholder-aware scheduler is aware of (1) the existence and semantics of placeholders, and (2) the fact that resources corresponding to a placeholder are not actually resource allocations—at least not until the placeholder is promoted to an actual resource allocation (e.g., upon successful completion of a migration task).

As is further discussed hereunder, the flow of FIG. 3B includes an operation 303 (which is not present in FIG. 3A) to add in an accounting for resources corresponding to placeholders. The need for this operation 303 is because it can happen that while the considered target node appears to have sufficient resources to satisfy requirements of a high-availability configuration (e.g., to satisfy a fault tolerance constraint, or to satisfy a headroom requirement, etc.), if there is a placeholder associated with the target node, then there is a likelihood that there will soon be a VM that is consuming the resources identified by the placeholder, and as such, when evaluating HA rules, the considered target node needs to be evaluated using the total resources that are demanded (e.g., resources corresponding to actually running VMs plus resources currently being reserved for migration of VMs) at the target node.

To explain in more detail, and as depicted by the time sequence of FIG. 3A, in absence of consideration for placeholders (such as is depicted by operation 303 of FIG. 3B), a naive path 102₂ might be taken. This is a strongly undesired path since it incorrectly deems (e.g., via decision 304₁) that given a particular instance of placement candidate 301₁, and given the resource determination of operation 302₁, there would be no HA rule violation (and the “No” path of decision 304₁) is taken, which in turn means that the particular instance of the placement candidate would be considered as a feasible placement for an HA configuration. On the contrary, if it was deemed that particular instance of placement candidate 301₁ would result in an HA configuration violation, then the “Yes” path of decision 304₁ should be taken which would result in a rejection of the placement candidate at terminus 306₁.

In accordance with this progression through flowchart 3A00, the determination that the particular placement candidate can be considered as a feasible placement for a particular configuration might be incorrect or, alternatively, might be correct only for a short period of time (e.g., until such time as a VM migration completes).

This is to be contrasted with FIG. 3B. Specifically, although the progression through flowchart 3B00 includes a step to add up resource use indications for a target node (operation 302₂), flowchart 3B00 also includes operation 303 that is executed so as to consider one or more placeholders at the target node. This leads to a correct determination shown as placeholder-aware path 308. In some instances, a resource usage calculation that includes consideration of placeholders might result in a determination (e.g., at decision 304₂) that some particular one or more subject cluster configuration rules would be violated, in which case the “Yes” path of decision 304₂ is taken, which path means that the considered instance of placement candidate 301₂ is deemed to be a rejected placement, and the placeholder candidate should be rejected (at terminus 306₂). On the other hand, if the determination (e.g., at decision 304₂) that some particular one or more subject cluster configuration rules would not be violated, in which case the “No” path of decision 304₂ is taken, which means that the considered instance of placement candidate 301₂ is deemed to be a configuration compliant placement, and the subject placeholder candidate can be considered as a feasible placement (step 307).

As such, the improvements of the flow of FIG. 3B prevent a candidate placement that would result in a non-compliant configuration from being considered as a feasible placement possibility.

### Transient Effects of Double Allocation

Since placeholder-aware schedulers comprehend the semantics of a placeholder, a placeholder-aware scheduler can avoid double counting (e.g., double counting resource placeholders) when making high-availability placement decisions. One desired effect of using a placeholder during migration is that the resources needed to complete a migration cannot be allocated by other processes. This is strongly desired at least in that it prevents migration failures due to unexpected unavailability of resources. Using this placeholder mechanism, however, has the consequence of temporarily double counting resources being used.

Consider a VM that has 20 GB of data space and 10 GB of code to be migrated over from a source location to a target location. Now, consider that during at least some portion of the migration period, 30 GB are allocated at the source location, and also that 30 GB are allocated at the target location. This is a transient condition of double allocation. The double allocation period will end when the VM at the source location is destroyed, thus returning the 30 GB back to the source node. Nevertheless, it can happen that rather than only 30 GB of allocation being seen in the cluster, 60 GB (i.e., 30 GB*2) is seen.

### Deployment of a Placeholder-Aware Placement Engine for High Availability

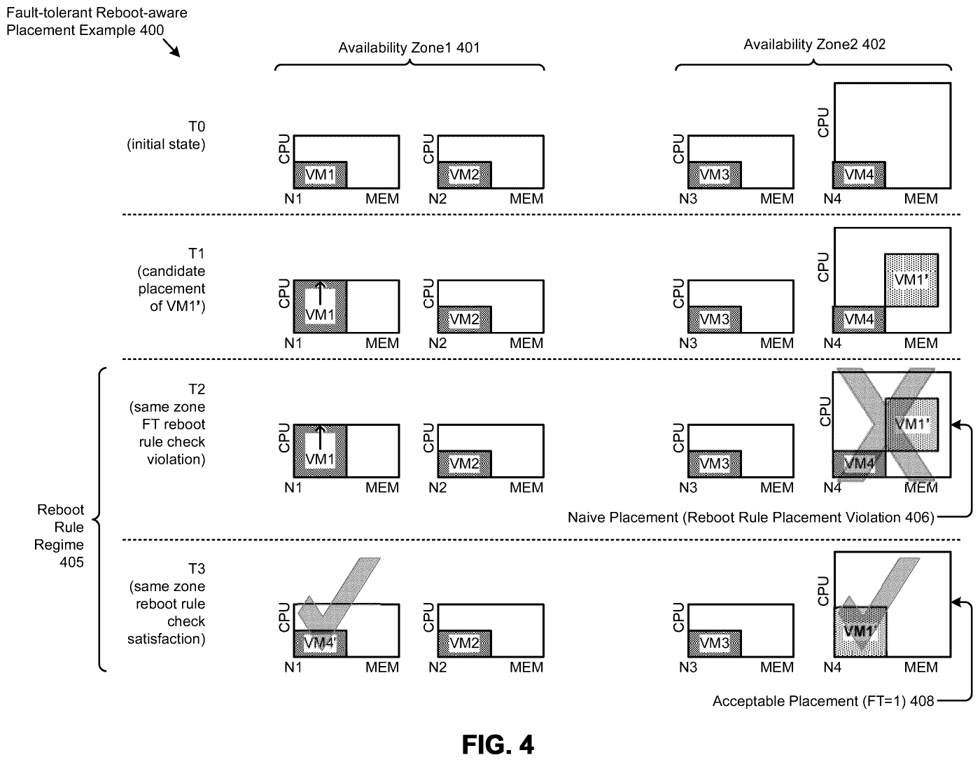

There are many different types of cluster configurations. In particular, there are many rules and rule terms (e.g., constraints, requirements, etc.) that affect high availability. One class of HA rules specifies how to place VMs across availability zones such that the cluster can be quickly restored in the event of a single node failure (e.g., FT=1) or in the event of a multiple node failure (e.g., FT=N, where N>1). Another class of HA rules involve placement of VMs across availability zones such that VMs can be rebooted at a node in the same availability zone as the availability zone that had experienced one or more node failures. These and other HA considerations are shown and discussed as pertains to FIG. 4.

FIG. 4 is a diagram showing an example fault-tolerant reboot-aware placement that results from invocation of a placeholder-aware placement engine. As an option, one or more variations of example fault-tolerant reboot-aware placement 400 or any aspect thereof may be implemented in the context of the architecture and functionality of the embodiments described herein and/or in any environment.

Some deployments and/or formations of nodes into a computing cluster result in a high-availability cluster that spans two or more availability zones. Accordingly a placeholder-aware placement engine needs to comprehend fault-tolerance VM reboot/restart rules and be able to apply such fault-tolerance VM reboot/restart rules both within an availability zone (if there are any corresponding intra-availability zone HA requirements in effect) as well as across availability zones (if there are corresponding inter-availability zone HA requirements in effect). One possible implementation of such a placeholder-aware placement engine that comprehends zone-aware fault-tolerance VM reboot/restart rules produces results such as are shown and described as pertains to FIG. 4.

Accordingly, the illustrative example of FIG. 4 is being presented to explain how the placement of a to-be-migrated VM can concurrently consider (1) availability zone constraints and (2) headroom constraints when considering a fault-tolerant reboot-aware placement rule. Suppose a fault-tolerant reboot-aware placement rule that has the semantics of, “in the event of a single node failure of a multi-node computing cluster, there must remain sufficient node resources in each of the availability zones of the computing cluster such that all of the VMs of the failed node can be rebooted on at least one of the remaining (i.e., non-failed) nodes in the same availability zone.” Further consider that there may be high-availability rules that have the semantics of, “in the event of a single node failure of a multi-node computing cluster, there must remain X % resource headroom in each node of the availability zones of a computing cluster.”

FIG. 4 depicts a scenario that leads to a fault-tolerant reboot-aware placement rule compliant cluster configuration. As shown, the initial state (at time=T0) of the computing cluster has four VMs: VM1, VM2, VM3, and VM4 that are distributed across four nodes: node N1, node N2, node N3, and node N4. Node N1 and node N2 are situated in a first availability zone (availability zone1 401), whereas Node N3 and node N4 are situated in a second availability zone (availability zone2 402). In this initial state, all VMs have some amount of headroom. Specifically, in this initial state, all VMs have some amount of headroom in terms of CPU resources as well as in terms of memory resources.

Computing on virtualized clusters is often very dynamic. Consider the situation that occurs when VM1 demands additional CPU resources (at time=T1). To satisfy the HA configuration, including the headroom rule, VM1 of node N1 in availability zone1 401 might be migrated to node N4 of availability zone2 402. However, in the context of HA cluster configurations, and in particular, given the requirement to satisfy reboot and headroom rules, this is a naive placement, at least in that, when checked for HA compliance (e.g., at time-T2), such a placement would present a reboot rule placement violation 406 during the period when a reboot rule regime 405 is active. At time=T2, in the event of failure of N3, it is impossible to restart both VM4 and VM1′ on the only remaining node of availability zone2.

In contrast, an acceptable placement 408 for fault tolerance FT=1 that does consider a fault-tolerant reboot-aware placement is shown under availability zone2 402 at time=T3. In some situations, multiple migrations needed to reach a compliant state can take place in a non-overlapping series of operations. In some situations, multiple migrations might be needed to reach a compliant state are undertaken in parallel with at least some of the migration operations being performed concurrently. In the example of FIG. 4, accomplishing the acceptable placement 408 included migrating not only the subject virtual machine (e.g., virtual machine VM1) from node N1 to target computing node N4, but also included migrating a further virtual machine (e.g., virtual machine VM4) from the target computing node N4 to a further target computing node (e.g., computing node N1).

Further details regarding approaches to concurrent migration of VMs are described in U.S. Pat. No. 11,188,368 titled “ASYNCHRONOUS WORKLOAD MIGRATION CONTROL” issued on Nov. 30, 2021, which is hereby incorporated by reference in its entirety.

Now, considering the aforementioned acceptable placement 408, in the event of failure of either one of node N₁ or node N₂, there remains sufficient node resources in the same availability zone such that all of the VMs of the failed node can be rebooted on at least one of the remaining (i.e., non-failed) nodes in the same availability zone. Further, the headroom requirement is satisfied since, in the event of a single node failure of a multi-node computing cluster, there indeed remains X % resource headroom in each node of the availability zone. This is also true for availability zone2. That is, in the event of a failure of either one of N₃ or N₄, there still remains sufficient node resources in the same availability zone such that all of the VMs of the failed node can be rebooted on at least one of the remaining (i.e., non-failed) nodes in the same availability zone. Further, the headroom requirement is satisfied since, in the event of a single node failure of the multi-node computing cluster, there indeed remains X % resource headroom in each node of the availability zone.

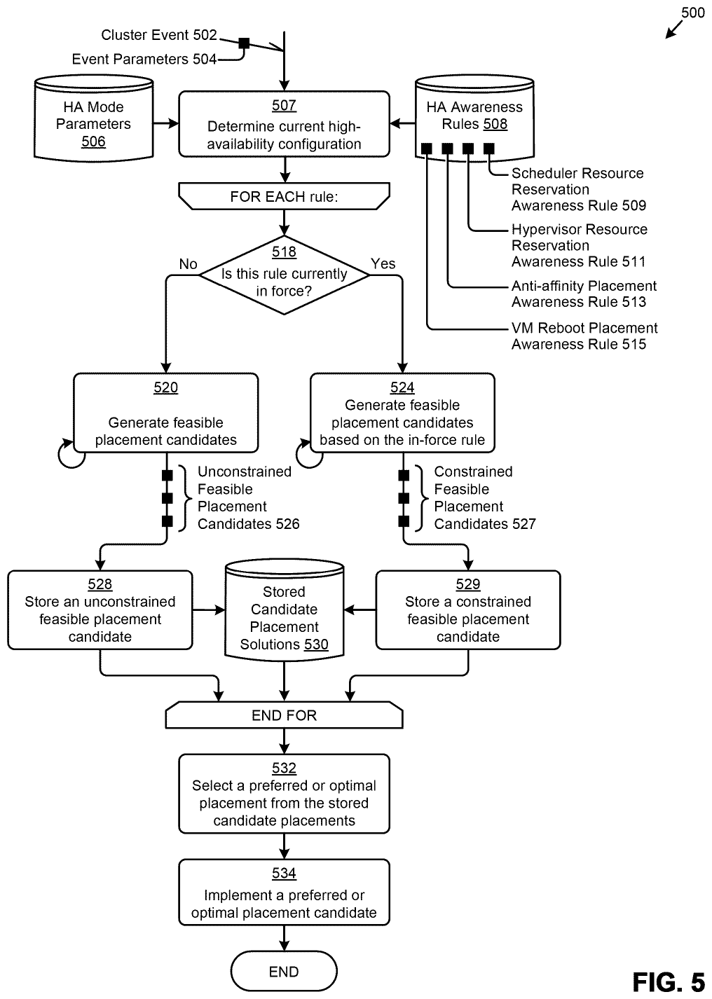

Any/all of the foregoing deficiencies in naive schedulers can be addressed by using an HA rule aware scheduling algorithm, an example of which is shown and described as pertains to FIG. 5.

FIG. 5 is a flowchart showing a cluster configuration using a high-availability rule aware scheduler. As an option, one or more variations of a cluster configuration using a high-availability rule aware scheduler 500 or any aspect thereof may be implemented in the context of the architecture and functionality of the embodiments described herein and/or in any environment.

Any/all of HA parameters and/or HA awareness rules can be addressed by using an HA-aware scheduler that examines HA parameters and/or HA awareness rules individually when generating and evaluating candidate placements. Such an HA-aware scheduler can be a part of, or integrated with, a controller virtual machine (CVM). Moreover, such an HA-aware scheduler can be used when initially placing VMs onto nodes or, such an HA-aware scheduler can be used when responding to a failure event or other cluster event affecting a subject computing cluster, or such an HA-aware scheduler can be use when migrating VMs between nodes in response to changing resource demands, including placing new VMs onto nodes of a computing cluster.

In the particular embodiment of FIG. 5, the HA-aware scheduler is entered upon occurrence of a cluster event 502, which cluster event might be responsive to any one or more of (1) a cluster event corresponding to an initial placement of VMs onto nodes, or (2) a failure cluster event affecting a subject computing cluster, or (3) a request for a revised placement such as would occur when migrating VMs between nodes. As shown, when cluster event 502 is raised to the high-availability rule aware scheduler 500, it might include, or be accompanied by, or be associated with, any number of event parameters 504. In some cases, the values of such event parameters influence operations undertaken by the high-availability rule aware scheduler. In some cases, the values of such event parameters are used in calculations undertaken by the high-availability rule aware scheduler.

In the particular embodiment of FIG. 5, the HA-aware scheduler first determines (at operation 507) the then-current cluster configuration. Determination of such a then-current cluster configuration might include consideration of values of the then-current HA mode parameters 506. In addition to consideration of the foregoing HA mode parameters, operation 507 considers a set of HA awareness rules 508. More particularly, when considering a then-current set of HA awareness rules, operation 507 can distinguish HA rules that are then in force. Many HA rules can be concurrently in force. Moreover there are many variations of HA rules that have rule-specific parameters. Any number of concurrently in-force rules, together with their corresponding parameters, can be considered individually.

As has been heretofore discussed, feasibility of a placement depends, at least in part, on whether or not an HA rule is being enforced. Accordingly, the HA-aware scheduler of FIG. 5 includes a test 518 to determine if a particular HA rule is being enforced or not. In accordance with the shown FOR EACH loop, all rules found in the HA awareness rules can be considered, whether or not the rule is in force.

Based on the result of test 518, the HA-aware scheduler may generate a different feasibility set. On one hand, when an HA rule is in force (i.e., corresponding to the “Yes” path of test 518), then one or more operations to generate placement candidates (e.g., operation 524) are carried out while observing whatever constraints might be specified in or implied in the considered rule. This results in any number of constrained feasible placement candidates 527. On the other hand, when an HA rule is not in force (i.e., corresponding to the “No” path of test 518), then the scheduler has more flexibility when generating feasible placement candidates. As is explained herein, if a scheduler is not configured to observe whatever constraints might be specified in or implied in an HA rule, then the generated placement candidates might violate one or more HA rules.

As one of ordinary skill in the art will recognize, a computing cluster may be composed of many nodes, which in turn are each capable of hosting many virtual machines. As such, even for small clusters it can happen that there may be many (e.g., tens, hundreds, thousands, or more) feasible placement solutions. In this embodiment, evaluation of feasible placement solutions to find a preferred or optimal placement solution is deferred until all possible feasible placement solutions have been enumerated.

Enumerated constrained feasible placement candidates 527 can be stored (at operation 529) into the shown stored candidate placement solutions 530. Similarly, enumerated unconstrained feasible placement candidates 526 can be stored (at operation 528) into the shown stored candidate placement solutions 530. Such stored placement solutions can be considered for preference or optimality in a later operation (e.g., at operation 532).

When iterating through the FOR EACH loop, each rule is considered on the basis of whether or not the rule is in force. In general, implementation of constrained feasible placement candidates 527 that correspond to any particular in-force HA rule may involve more processing than does implementation of unconstrained feasible placement candidates 526 (e.g., such as are generated at operation 520) when the same particular HA rule is not in force.

The determination of preference or optimality (e.g., operation 532) may involve parameters that are not shown in FIG. 5. For example, consider two feasible placement solutions, one of which demands an egress of data from a cloud infrastructure (at a cost, or incurring unwanted latency to accomplish the egress) and another feasible placement solution that does not require egress at all. All other aspects being equal, the feasible placement solution that does not require egress would be preferred. Such a preferred or optimal solution can then be implemented (operation 534), thus completing this portion of a response to cluster event 502.

It should be noted that the shown HA awareness rules 508 (e.g., scheduler resource reservation awareness rule 509, hypervisor resource reservation awareness rule 511, anti-affinity placement awareness rule 513, and VM reboot placement awareness rule 515) are purely for purposes of illustration. There are many other possible HA rules, and the presence or absence of rules in the instant discussion should not be considered to be limiting of the scope of the disclosure.

Moreover, many differing semantics are possible when considering an HA rule. Strictly as examples, a scheduler resource reservation awareness rule can mean that a scheduler or placement engine is responsible for enforcing placements, or a scheduler resource reservation awareness rule can mean merely that such a rule can be observed by any operational entity. As another example, a hypervisor resource reservation awareness rule can mean that a hypervisor is responsible for enforcing placements, or a hypervisor resource reservation awareness rule can mean merely that such a rule can be observed by any operational entity. As a further example, an anti-affinity placement awareness rule can mean that no two VMs are to be placed on a given hypervisor, or an anti-affinity placement awareness rule can mean that no two VMs are to be placed on a given hypervisor except during a transient operation (e.g., a migration).

As yet a further example, a VM reboot placement awareness rule can mean that all VMs are placed such that in event of a failure of a node of a subject cluster, all VMs of the failed node can be restarted across one or more of the non-failed nodes of the cluster. Alternatively, a VM reboot placement awareness rule can mean that all VMs of a particular availability zone are placed such that in event of failed node of the particular availability zone, all VMs of the failed node can be restarted at one or more of the non-failed nodes that are situated in the same availability zone as the failed node.

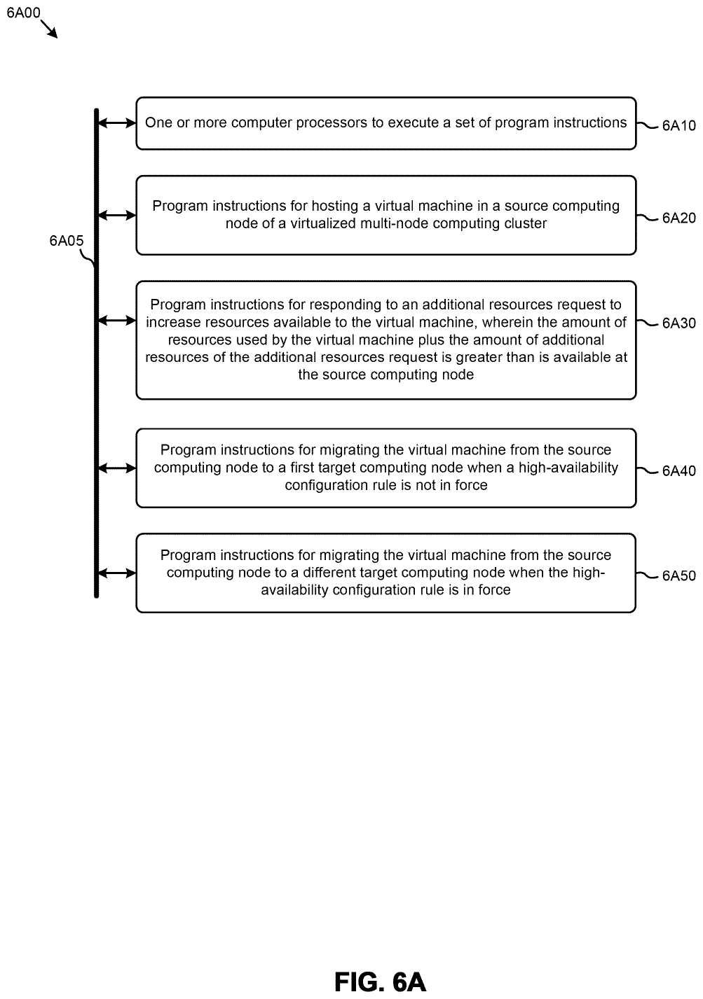

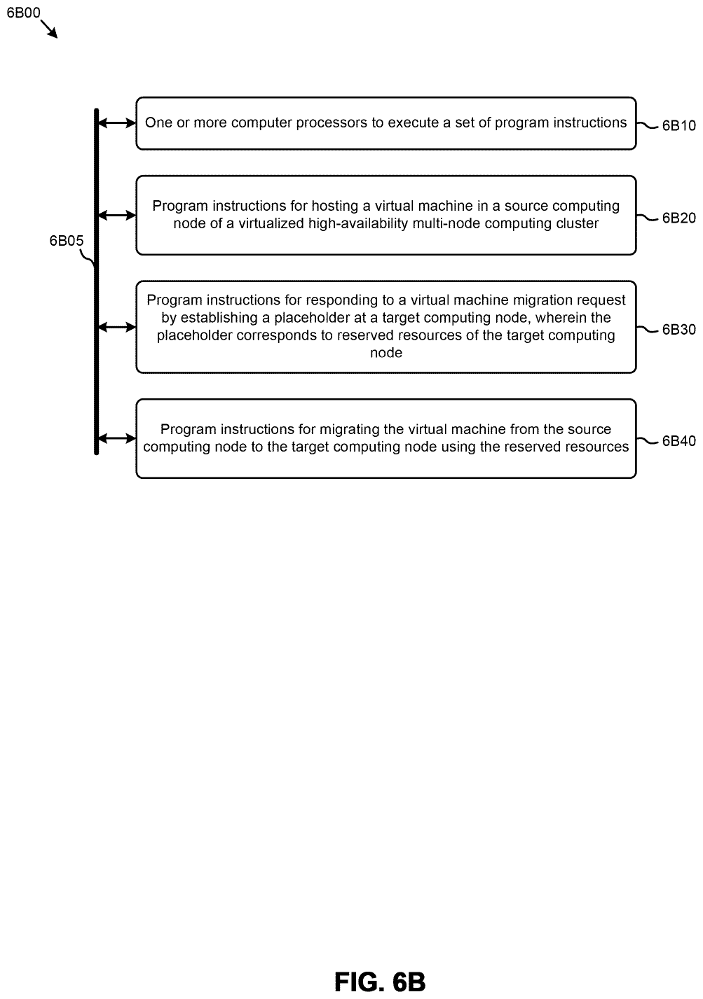

FIG. 6A depicts system 6A00 as an arrangement of computing modules that are interconnected so as to operate cooperatively to implement certain of the herein-disclosed embodiments. This and other embodiments present particular arrangements of elements that, individually or as combined, serve to form improved technological processes that address legacy schedulers are unaware of certain high-availability placement requirements. The partitioning of system 6A00 is merely illustrative and other partitions are possible.

FIG. 6A depicts a block diagram of a system to perform certain functions of a computer system. As an option, the system 6A00 may be implemented in the context of the architecture and functionality of the embodiments described herein. Of course, however, system 6A00 or any operation therein may be carried out in any desired environment. As shown, system 6A00 comprises at least one processor and at least one memory, the memory serving to store program instructions corresponding to the operations of the system. Any operation can be implemented in whole or in part using program instructions accessible by a module.

The modules are connected to a communication path 6A05, and any operation can communicate with any other operations over communication path 6A05. The modules of the system can, individually or in combination, perform method operations within system 6A00. Any operations performed within system 6A00 may be performed in any order unless as may be specified in the claims. The shown embodiment implements a portion of a computer system, presented as system 6A00, comprising one or more computer processors to execute a set of program code instructions (module 6A10) and modules for accessing memory to hold program code instructions to perform: hosting a virtual machine in a source computing node of a virtualized multi-node computing cluster (module 6A20); responding to an additional resources request to increase resources available to the virtual machine, wherein the amount of the resources used by the virtual machine plus the amount of additional resources of the additional resources request is greater than is available at the source computing node (module 6A30); migrating the virtual machine from the source computing node to a first target computing node when a high-availability configuration rule is not in force (module 6A40); and migrating the virtual machine from the source computing node to a different target computing node when the high-availability configuration rule is in force (module 6A50).

Variations of the foregoing may include more or fewer of the shown modules. Certain variations may perform more or fewer (or different) steps and/or certain variations may use data elements in more, or in fewer, or in different operations. Still further, some embodiments include variations in the operations performed, and some embodiments include variations of aspects of the data elements used in the operations.

FIG. 6B depicts a block diagram of a system to perform certain functions of a computer system. As an option, system 6B00 may be implemented in the context of the architecture and functionality of the embodiments described herein. Of course, however, the system 6B00 or any operation therein may be carried out in any desired environment.

The shown system 6B00 comprises one or more computer processors to execute a set of program instructions (module 6B10), a module comprising at least one processor and a memory, and other modules, any or all of which are connected to a communication link 6B05. Any particular module can communicate with other modules over communication link 6B05. The modules of the system can, individually or in combination, perform method steps within system 6B00. Any method steps performed within system 6B00 may be performed in any order unless as may be specified in the claims.

As shown, system 6B00 comprising modules for: hosting a virtual machine in a source computing node of a virtualized high-availability multi-node computing cluster (module 6B20); responding to a virtual machine migration request by establishing a placeholder at a target computing node, wherein the placeholder corresponds to reserved resources of the target computing node (module 6B30); and a module for migrating the virtual machine from the source computing node to the target computing node using the reserved resources (module 6B40).

### System Architecture Overview

### Additional System Architecture Examples

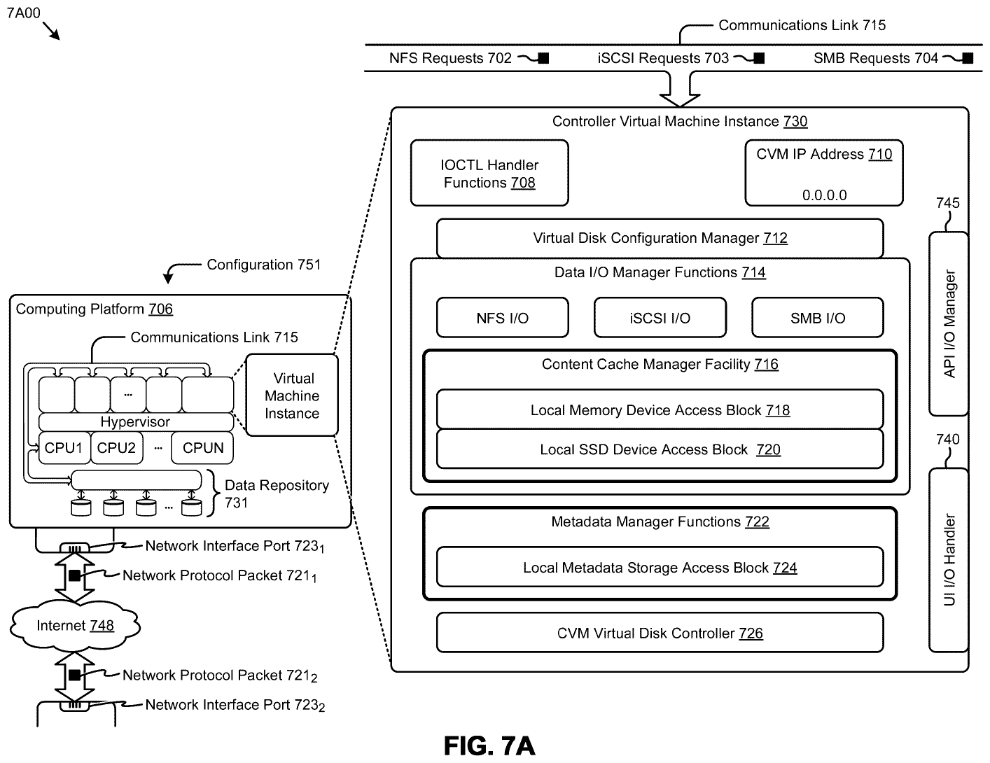

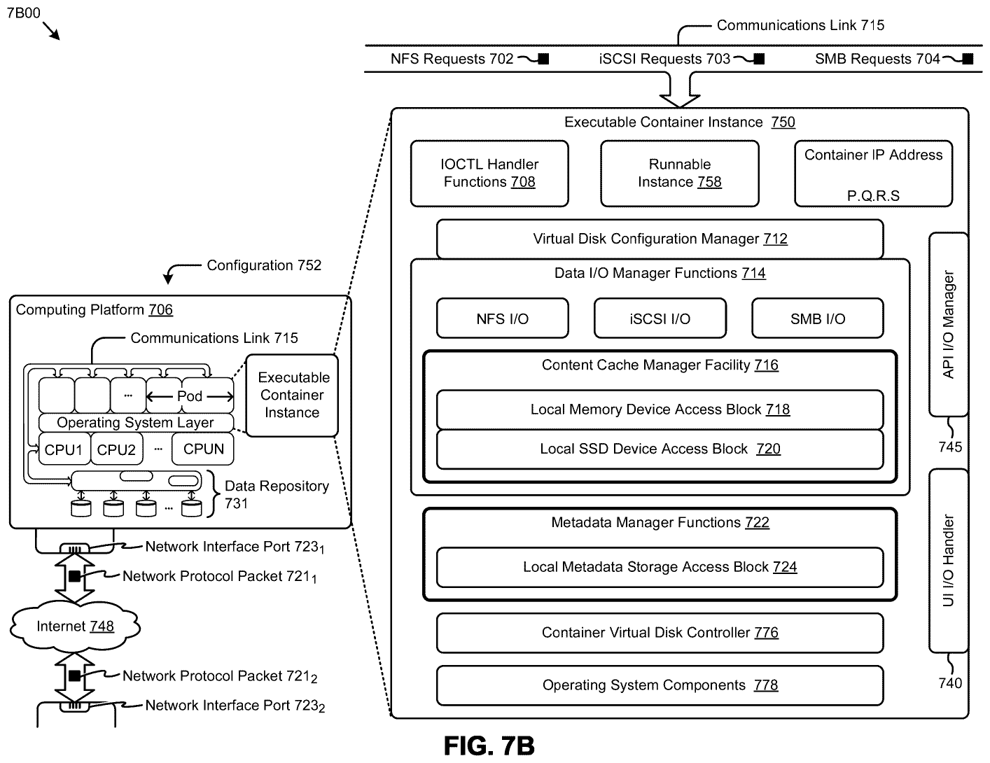

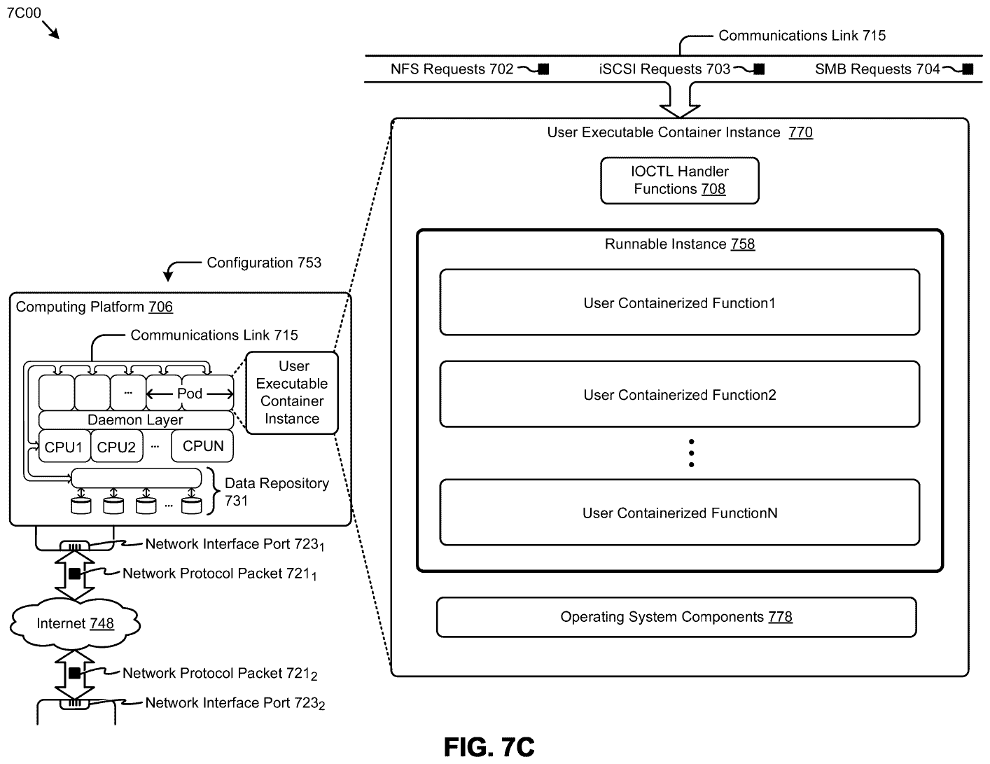

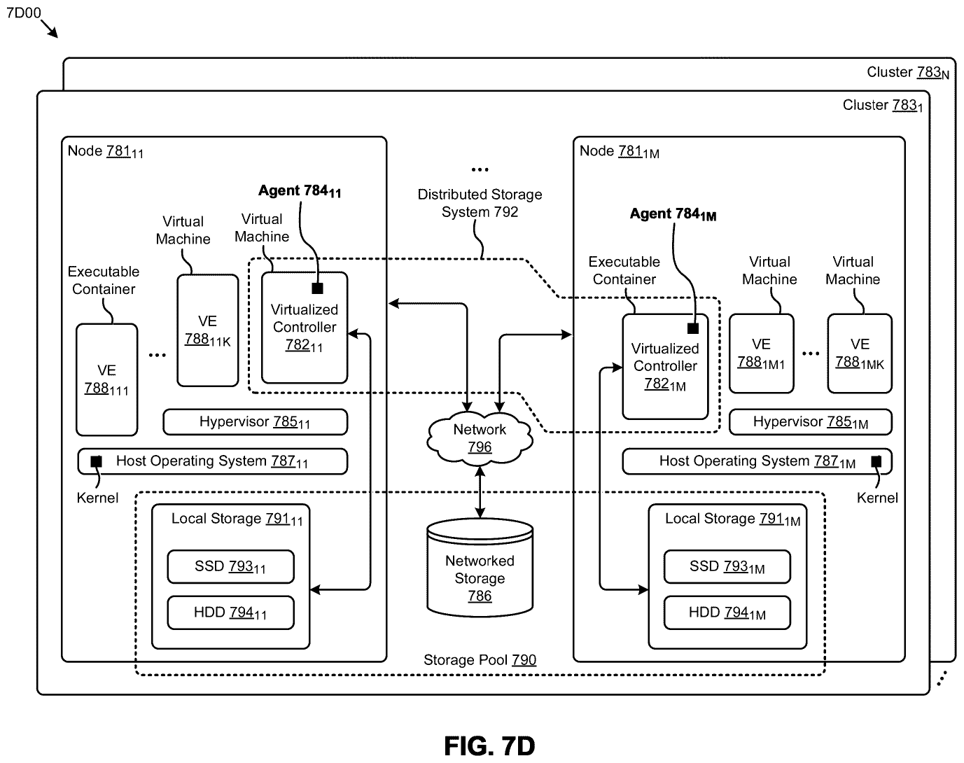

All or portions of any of the foregoing techniques can be partitioned into one or more modules and instanced within, or as, or in conjunction with, a virtualized controller in a virtual computing environment. Some example instances of virtualized controllers situated within various virtual computing environments are shown and discussed as pertains to FIG. 7A, FIG. 7B, FIG. 7C, and FIG. 7D.

FIG. 7A depicts a virtualized controller as implemented in the shown virtual machine architecture 7A00. The heretofore-disclosed embodiments, including variations of any virtualized controllers, can be implemented in distributed systems where a plurality of networked-connected devices communicate and coordinate actions using inter-component messaging.

As used in these embodiments, a virtualized controller is a collection of software instructions that serve to abstract details of underlying hardware or software components from one or more higher-level processing entities. A virtualized controller can be implemented as a virtual machine, as an executable container, or within a layer (e.g., such as a layer in a hypervisor). Furthermore, as used in these embodiments, distributed systems are collections of interconnected components that are designed for, or dedicated to, storage operations as well as being designed for, or dedicated to, computing and/or networking operations.

Interconnected components in a distributed system can operate cooperatively to achieve a particular objective such as to provide high-performance computing, high-performance networking capabilities, and/or high-performance storage and/or high-capacity storage capabilities. For example, a first set of components of a distributed computing system can coordinate to efficiently use a set of computational or compute resources, while a second set of components of the same distributed computing system can coordinate to efficiently use the same or a different set of data storage facilities.

A hyperconverged system coordinates the efficient use of compute and storage resources by and between the components of the distributed system. Adding a hyperconverged unit to a hyperconverged system expands the system in multiple dimensions. As an example, adding a hyperconverged unit to a hyperconverged system can expand the system in the dimension of storage capacity while concurrently expanding the system in the dimension of computing capacity and also in the dimension of networking bandwidth. Components of any of the foregoing distributed systems can comprise physically and/or logically distributed autonomous entities.

Physical and/or logical collections of such autonomous entities can sometimes be referred to as nodes. In some hyperconverged systems, compute and storage resources can be integrated into a unit of a node. Multiple nodes can be interrelated into an array of nodes, which nodes can be grouped into physical groupings (e.g., arrays) and/or into logical groupings or topologies of nodes (e.g., spoke-and-wheel topologies, rings, etc.). Some hyperconverged systems implement certain aspects of virtualization. For example, in a hypervisor-assisted virtualization environment, certain of the autonomous entities of a distributed system can be implemented as virtual machines. As another example, in some virtualization environments, autonomous entities of a distributed system can be implemented as executable containers. In some systems and/or environments, hypervisor-assisted virtualization techniques and operating system virtualization techniques are combined.

As shown, virtual machine architecture 7A00 comprises a collection of interconnected components suitable for implementing embodiments of the present disclosure and/or for use in the herein-described environments. Moreover, virtual machine architecture 7A00 includes a virtual machine instance in configuration 751 that is further described as pertaining to controller virtual machine instance 730. Configuration 751 supports virtual machine instances that are deployed as user virtual machines, or controller virtual machines or both. Such virtual machines interface with a hypervisor (as shown). Some virtual machines are configured for processing of storage inputs or outputs (I/O or IO) as received from any or every source within the computing platform. An example implementation of such a virtual machine that processes storage I/O is depicted as 730.

In this and other configurations, a controller virtual machine instance receives block I/O storage requests as network file system (NFS) requests in the form of NFS requests 702, and/or internet small computer system interface (iSCSI) block IO requests in the form of iSCSI requests 703, and/or Samba file system (SMB) requests in the form of SMB requests 704. The controller virtual machine (CVM) instance publishes and responds to an internet protocol (IP) address (e.g., CVM IP address 710). Various forms of input and output can be handled by one or more IO control (IOCTL) handler functions (e.g., IOCTL handler functions 708) that interface to other functions such as data IO manager functions 714 and/or metadata manager functions 722. As shown, the data IO manager functions can include communication with virtual disk configuration manager 712 and/or can include direct or indirect communication with any of various block IO functions (e.g., NFS IO, iSCSI IO, SMB IO, etc.).

In addition to block IO functions, configuration 751 supports input or output (IO) of any form (e.g., block IO, streaming IO) and/or packet-based IO such as hypertext transport protocol (HTTP) traffic, etc., through either or both of a user interface (UI) handler such as UI IO handler 740 and/or through any of a range of application programming interfaces (APIs), possibly through API IO manager 745.

Communications link 715 can be configured to transmit (e.g., send, receive, signal, etc.) any type of communications packets comprising any organization of data items. The data items can comprise a payload data, a destination address (e.g., a destination IP address) and a source address (e.g., a source IP address), and can include various packet processing techniques (e.g., tunneling), encodings (e.g., encryption), and/or formatting of bit fields into fixed-length blocks or into variable length fields used to populate the payload. In some cases, packet characteristics include a version identifier, a packet or payload length, a traffic class, a flow label, etc. In some cases, the payload comprises a data structure that is encoded and/or formatted to fit into byte or word boundaries of the packet.

In some embodiments, hard-wired circuitry may be used in place of, or in combination with, software instructions to implement aspects of the disclosure. Thus, embodiments of the disclosure are not limited to any specific combination of hardware circuitry and/or software. In embodiments, the term “logic” shall mean any combination of software or hardware that is used to implement all or part of the disclosure.

The term “computer readable medium” or “computer usable medium” as used herein refers to any medium that participates in providing instructions to a data processor for execution. Such a medium may take many forms including, but not limited to, non-volatile media and volatile media. Non-volatile media includes any non-volatile storage medium, for example, solid state storage devices (SSDs) or optical or magnetic disks such as hard disk drives (HDDs) or hybrid disk drives, or random access persistent memories (RAPMs) or optical or magnetic media drives such as paper tape or magnetic tape drives. Volatile media includes dynamic memory such as random access memory. As shown, controller virtual machine instance 730 includes content cache manager facility 716 that accesses storage locations, possibly including local dynamic random access memory (DRAM) (e.g., through local memory device access block 718) and/or possibly including accesses to local solid state storage (e.g., through local SSD device access block 720).

Common forms of computer readable media include any non-transitory computer readable medium, for example, floppy disk, flexible disk, hard disk, magnetic tape, or any other magnetic medium; compact disk read-only memory (CD-ROM) or any other optical medium; punch cards, paper tape, or any other physical medium with patterns of holes; or any random access memory (RAM), programmable read-only memory (PROM), erasable programmable read-only memory (EPROM), flash memory EPROM (FLASH-EPROM), or any other memory chip or cartridge. Any data can be stored, for example, in any form of data repository 731, which in turn can be formatted into any one or more storage areas, and which can comprise parameterized storage accessible by a key (e.g., a filename, a table name, a block address, an offset address, etc.). Data repository 731 can store any forms of data, and may comprise a storage area dedicated to storage of metadata pertaining to the stored forms of data. In some cases, metadata can be divided into portions. Such portions and/or cache copies can be stored in the storage data repository and/or in a local storage area (e.g., in local DRAM areas and/or in local SSD areas). Such local storage can be accessed using functions provided by local metadata storage access block 724. The data repository 731 can be configured using CVM virtual disk controller 726, which can in turn manage any number or any configuration of virtual disks.

Execution of a sequence of instructions to practice certain embodiments of the disclosure are performed by one or more instances of a software instruction processor, or a processing element such as a central processing unit (CPU) or data processor or graphics processing unit (GPU), or such as any type or instance of a processor (e.g., CPU1, CPU2, . . . , CPUN). According to certain embodiments of the disclosure, two or more instances of configuration 751 can be coupled by communications link 715 (e.g., backplane, local area network, public switched telephone network, wired or wireless network, etc.) and each instance may perform respective portions of sequences of instructions as may be required to practice embodiments of the disclosure.

The shown computing platform 706 is interconnected to the Internet 748 through one or more network interface ports (e.g., network interface port 7231 and network interface port 7232). Configuration 751 can be addressed through one or more network interface ports using an IP address. Any operational element within computing platform 706 can perform sending and receiving operations using any of a range of network protocols, possibly including network protocols that send and receive packets (e.g., network protocol packet 7211 and network protocol packet 7212).

Computing platform 706 may transmit and receive messages that can be composed of configuration data and/or any other forms of data and/or instructions organized into a data structure (e.g., communications packets). In some cases, the data structure includes program instructions (e.g., application code) communicated through the Internet 748 and/or through any one or more instances of communications link 715. Received program instructions may be processed and/or executed by a CPU as it is received and/or program instructions may be stored in any volatile or non-volatile storage for later execution. Program instructions can be transmitted via an upload (e.g., an upload from an access device over the Internet 748 to computing platform 706). Further, program instructions and/or the results of executing program instructions can be delivered to a particular user via a download (e.g., a download from computing platform 706 over the Internet 748 to an access device).

Configuration 751 is merely one sample configuration. Other configurations or partitions can include further data processors, and/or multiple communications interfaces, and/or multiple storage devices, etc. within a partition. For example, a partition can bound a multi-core processor (e.g., possibly including embedded or collocated memory), or a partition can bound a computing cluster having a plurality of computing elements, any of which computing elements are connected directly or indirectly to a communications link. A first partition can be configured to communicate to a second partition. A particular first partition and a particular second partition can be congruent (e.g., in a processing element array) or can be different (e.g., comprising disjoint sets of components).

A cluster is often embodied as a collection of computing nodes that can communicate between each other through a local area network (LAN) and/or through a virtual LAN (VLAN) and/or over a backplane. Some clusters are characterized by assignment of a particular set of the aforementioned computing nodes to access a shared storage facility that is also configured to communicate over the local area network or backplane. In many cases, the physical bounds of a cluster are defined by a mechanical structure such as a cabinet or such as a chassis or rack that hosts a finite number of mounted-in computing units. A computing unit in a rack can take on a role as a server, or as a storage unit, or as a networking unit, or any combination therefrom. In some cases, a unit in a rack is dedicated to provisioning of power to other units. In some cases, a unit in a rack is dedicated to environmental conditioning functions such as filtering and movement of air through the rack and/or temperature control for the rack. Racks can be combined to form larger clusters. For example, the LAN of a first rack having a quantity of 32 computing nodes can be interfaced with the LAN of a second rack having 16 nodes to form a two-rack cluster of 48 nodes. The former two LANs can be configured as subnets, or can be configured as one VLAN. Multiple clusters can communicate between one module to another over a WAN (e.g., when geographically distal) or a LAN (e.g., when geographically proximal).

As used herein, a module can be implemented using any mix of any portions of memory and any extent of hard-wired circuitry including hard-wired circuitry embodied as a data processor. Some embodiments of a module include one or more special-purpose hardware components (e.g., power control, logic, sensors, transducers, etc.). A data processor can be organized to execute a processing entity that is configured to execute as a single process or configured to execute using multiple concurrent processes to perform work. A processing entity can be hardware-based (e.g., involving one or more cores) or software-based, and/or can be formed using a combination of hardware and software that implements logic, and/or can carry out computations and/or processing steps using one or more processes and/or one or more tasks and/or one or more threads or any combination thereof.

Some embodiments of a module include instructions that are stored in a memory for execution so as to facilitate operational and/or performance characteristics pertaining to techniques for high-availability virtual machine placement across a plurality of computing nodes of a computing infrastructure. In some embodiments, a module may include one or more state machines and/or combinational logic used to implement or facilitate the operational and/or performance characteristics pertaining to techniques for high-availability virtual machine placement across a plurality of computing nodes of a computing infrastructure.

Various implementations of the data repository comprise storage media organized to hold a series of records or files such that individual records or files are accessed using a name or key (e.g., a primary key or a combination of keys and/or query clauses). Such files or records can be organized into one or more data structures (e.g., data structures used to implement or facilitate aspects of techniques for high-availability virtual machine placement across a plurality of computing nodes of a computing infrastructure). Such files or records can be brought into and/or stored in volatile or non-volatile memory. More specifically, the occurrence and organization of the foregoing files, records, and data structures improve the way that the computer stores and retrieves data in memory, for example, to improve the way data is accessed when the computer is performing operations pertaining to techniques for high-availability virtual machine placement across a plurality of computing nodes of a computing infrastructure, and/or for improving the way data is manipulated when performing computerized operations pertaining to implementation of placeholder-aware placement engines that observe rules covering placement requirements for high-availability computing clusters.

Further details regarding general approaches to managing data repositories are described in U.S. Pat. No. 8,601,473 titled “ARCHITECTURE FOR MANAGING I/O AND STORAGE FOR A VIRTUALIZATION ENVIRONMENT” issued on Dec. 3, 2013, which is hereby incorporated by reference in its entirety.

Further details regarding general approaches to managing and maintaining data in data repositories are described in U.S. Pat. No. 8,549,518 titled “METHOD AND SYSTEM FOR IMPLEMENTING A MAINTENANCE SERVICE FOR MANAGING I/O AND STORAGE FOR A VIRTUALIZATION ENVIRONMENT” issued on Oct. 1, 2013, which is hereby incorporated by reference in its entirety.

FIG. 7B depicts a virtualized controller implemented by containerized architecture 7B00. The containerized architecture comprises a collection of interconnected components suitable for implementing embodiments of the present disclosure and/or for use in the herein-described environments. Moreover, the shown containerized architecture 7B00 includes an executable container instance in configuration 752 that is further described as pertaining to executable container instance 750. Configuration 752 includes an operating system layer (as shown) that performs addressing functions such as providing access to external requestors (e.g., user virtual machines or other processes) via an IP address (e.g., “P.Q.R.S”, as shown). Providing access to external requestors can include implementing all or portions of a protocol specification, possibly including the hypertext transport protocol (HTTP or “http:”) and/or possibly handling port-specific functions. In this and other embodiments, external requestors (e.g., user virtual machines or other processes) rely on the aforementioned addressing functions to access a virtualized controller for performing all data storage functions. Furthermore, when data input or output requests are received from a requestor running on a first node are received at the virtualized controller on that first node, then in the event that the requested data is located on a second node, the virtualized controller on the first node accesses the requested data by forwarding the request to the virtualized controller running at the second node. In some cases, a particular input or output request might be forwarded again (e.g., an additional or Nth time) to further nodes. As such, when responding to an input or output request, a first virtualized controller on the first node might communicate with a second virtualized controller on the second node, which second node has access to particular storage devices on the second node or, the virtualized controller on the first node may communicate directly with storage devices on the second node.

The operating system layer can perform port forwarding to any executable container (e.g., executable container instance 750). An executable container instance can be executed by a processor. Runnable portions of an executable container instance sometimes derive from an executable container image, which in turn might include all, or portions of any of, a Java archive repository (JAR) and/or its contents, and/or a script or scripts and/or a directory of scripts, and/or a virtual machine configuration, and may include any dependencies therefrom. In some cases, a configuration within an executable container might include an image comprising a minimum set of runnable code. Contents of larger libraries and/or code or data that would not be accessed during runtime of the executable container instance can be omitted from the larger library to form a smaller library composed of only the code or data that would be accessed during runtime of the executable container instance. In some cases, start-up time for an executable container instance can be much faster than start-up time for a virtual machine instance, at least inasmuch as the executable container image might be much smaller than a respective virtual machine instance. Furthermore, start-up time for an executable container instance can be much faster than start-up time for a virtual machine instance, at least inasmuch as the executable container image might have many fewer code and/or data initialization steps to perform than a respective virtual machine instance.

An executable container instance can serve as an instance of an application container or as a controller executable container. Any executable container of any sort can be rooted in a directory system and can be configured to be accessed by file system commands (e.g., “Is”, “dir”, etc.). The executable container might optionally include operating system components 778, however such a separate set of operating system components need not be provided. As an alternative, an executable container can include runnable instance 758, which is built (e.g., through compilation and linking, or just-in-time compilation, etc.) to include any or all of any or all library entries and/or operating system (OS) functions, and/or OS-like functions as may be needed for execution of the runnable instance. In some cases, a runnable instance can be built with a virtual disk configuration manager, any of a variety of data IO management functions, etc. In some cases, a runnable instance includes code for, and access to, container virtual disk controller 776. Such a container virtual disk controller can perform any of the functions that the aforementioned CVM virtual disk controller 726 can perform, yet such a container virtual disk controller does not rely on a hypervisor or any particular operating system so as to perform its range of functions.

In some environments, multiple executable containers can be collocated and/or can share one or more contexts. For example, multiple executable containers that share access to a virtual disk can be assembled into a pod (e.g., a Kubernetes pod). Pods provide sharing mechanisms (e.g., when multiple executable containers are amalgamated into the scope of a pod) as well as isolation mechanisms (e.g., such that the namespace scope of one pod does not share the namespace scope of another pod).

FIG. 7C depicts a virtualized controller implemented by a daemon-assisted containerized architecture 7C00. The containerized architecture comprises a collection of interconnected components suitable for implementing embodiments of the present disclosure and/or for use in the herein-described environments. Moreover, the shown daemon-assisted containerized architecture includes a user executable container instance in configuration 753 that is further described as pertaining to user executable container instance 770. Configuration 753 includes a daemon layer (as shown) that performs certain functions of an operating system.

User executable container instance 770 comprises any number of user containerized functions (e.g., user containerized function1, user containerized function2, . . . , user containerized functionN). Such user containerized functions can execute autonomously or can be interfaced with or wrapped in a runnable object to create a runnable instance (e.g., runnable instance 758). In some cases, the shown operating system components 778 comprise portions of an operating system, which portions are interfaced with or included in the runnable instance and/or any user containerized functions. In this embodiment of a daemon-assisted containerized architecture, the computing platform 706 might or might not host operating system components other than operating system components 778. More specifically, the shown daemon might or might not host operating system components other than operating system components 778 of user executable container instance 770.

The virtual machine architecture 7A00 of FIG. 7A and/or the containerized architecture 7B00 of FIG. 7B and/or the daemon-assisted containerized architecture 7C00 of FIG. 7C can be used in any combination to implement a distributed platform that contains multiple servers and/or nodes that manage multiple tiers of storage where the tiers of storage might be formed using the shown data repository 731 and/or any forms of network accessible storage. As such, the multiple tiers of storage may include storage that is accessible over communications link 715. Such network accessible storage may include cloud storage or networked storage (NAS) and/or may include all or portions of a storage area network (SAN). Unlike prior approaches, the presently-discussed embodiments permit local storage that is within or directly attached to the server or node to be managed as part of a storage pool. Such local storage can include any combinations of the aforementioned SSDs and/or HDDs and/or RAPMs and/or hybrid disk drives. The address spaces of a plurality of storage devices, including both local storage (e.g., using node-internal storage devices) and any forms of network-accessible storage, are collected to form a storage pool having a contiguous address space.

Significant performance advantages can be gained by allowing the virtualization system to access and utilize local (e.g., node-internal) storage. This is because I/O performance is typically much faster when performing access to local storage as compared to performing access to networked storage or cloud storage. This faster performance for locally attached storage can be increased even further by using certain types of optimized local storage devices such as SSDs or RAPMs, or hybrid HDDs, or other types of high-performance storage devices.

In example embodiments, each storage controller exports one or more block devices or NFS or iSCSI targets that appear as disks to user virtual machines or user executable containers. These disks are virtual since they are implemented by the software running inside the storage controllers. Thus, to the user virtual machines or user executable containers, the storage controllers appear to be exporting a clustered storage appliance that contains some disks. User data (including operating system components) in the user virtual machines resides on these virtual disks.

Any one or more of the aforementioned virtual disks (or “vDisks”) can be structured from any one or more of the storage devices in the storage pool. As used herein, the term “vDisk” refers to a storage abstraction that is exposed by a controller virtual machine or container to be used by another virtual machine or container. In some embodiments, the vDisk is exposed by operation of a storage protocol such as iSCSI or NFS or SMB. In some embodiments, a vDisk is mountable. In some embodiments, a vDisk is mounted as a virtual storage device.

In example embodiments, some or all of the servers or nodes run virtualization software. Such virtualization software might include a hypervisor (e.g., as shown in configuration 751 of FIG. 7A) to manage the interactions between the underlying hardware and user virtual machines or containers that run client software.

Distinct from user virtual machines or user executable containers, a special controller virtual machine (e.g., as depicted by controller virtual machine instance 730) or as a special controller executable container is used to manage certain storage and I/O activities. Such a special controller virtual machine is referred to as a “CVM”, or as a controller executable container, or as a service virtual machine (SVM), or as a service executable container, or as a storage controller. In some embodiments, multiple storage controllers are hosted by multiple nodes. Such storage controllers coordinate within a computing system to form a computing cluster.

The storage controllers are not formed as part of specific implementations of hypervisors. Instead, the storage controllers run above hypervisors on the various nodes and work together to form a distributed system that manages all of the storage resources, including the locally attached storage, the networked storage, and the cloud storage. In example embodiments, the storage controllers run as special virtual machines-above the hypervisors-thus, the approach of using such special virtual machines can be used and implemented within any virtual machine architecture. Furthermore, the storage controllers can be used in conjunction with any hypervisor from any virtualization vendor and/or implemented using any combinations or variations of the aforementioned executable containers in conjunction with any host operating system components.

FIG. 7D depicts a distributed virtualization system in a multi-cluster environment 7D00. The shown distributed virtualization system is configured to be used to implement the herein disclosed techniques. Specifically, the distributed virtualization system of FIG. 7D comprises multiple clusters (e.g., cluster 783₁, . . . , cluster 783_{N}) comprising multiple nodes that have multiple tiers of storage in a storage pool. Representative nodes (e.g., node 781₁₁, . . . , node 781_{1M}) and storage pool 790 associated with cluster 783₁ are shown. Each node can be associated with one server, multiple servers, or portions of a server. The nodes can be associated (e.g., logically and/or physically) with the clusters. As shown, the multiple tiers of storage include storage that is accessible through a network 796, such as a networked storage 786 (e.g., a storage area network or SAN, network attached storage or NAS, etc.). The multiple tiers of storage further include instances of local storage (e.g., local storage 791₁₁, . . . , local storage 791_{1M}). For example, the local storage can be within or directly attached to a server and/or appliance associated with the nodes. Such local storage can include solid state drives (SSD 793₁₁, . . . , SSD 793_{1M}), hard disk drives (HDD 794₁₁, HDD 794_{1M}), and/or other storage devices.

As shown, any of the nodes of the distributed virtualization system can implement one or more user virtualized entities (VEs) such as the virtualized entity (VE) instances shown as VE 788₁₁₁, . . . , VE 788_{11K}, . . . , VE 788_{1M1}, . . . , VE 788_{1MK}, and/or a distributed virtualization system can implement one or more virtualized entities that may be embodied as a virtual machines (VM) and/or as an executable container. The VEs can be characterized as software-based computing “machines” implemented in a container-based or hypervisor-assisted virtualization environment that emulates underlying hardware resources (e.g., CPU, memory, etc.) of the nodes. For example, multiple VMs can operate on one physical machine (e.g., node host computer) running a single host operating system (e.g., host operating system 787₁₁, . . . , host operating system 787_{1M}), while the VMs run multiple applications on various respective guest operating systems. Such flexibility can be facilitated at least in part by a hypervisor (e.g., hypervisor 785₁₁, . . . , hypervisor 785_{1M}), which hypervisor is logically located between the various guest operating systems of the VMs and the host operating system of the physical infrastructure (e.g., node).

As an alternative, executable containers may be implemented at the nodes in an operating system-based virtualization environment or in a containerized virtualization environment. The executable containers comprise groups of processes and/or may use resources (e.g., memory, CPU, disk, etc.) that are isolated from the node host computer and other containers. Such executable containers directly interface with the kernel of the host operating system (e.g., host operating system 787₁₁, . . . , host operating system 787_{1M}) without, in most cases, a hypervisor layer. This lightweight implementation can facilitate efficient distribution of certain software components, such as applications or services (e.g., micro-services). Any node of a distributed virtualization system can implement both a hypervisor-assisted virtualization environment and a container virtualization environment for various purposes. Also, any node of a distributed virtualization system can implement any one or more types of the foregoing virtualized controllers so as to facilitate access to storage pool 790 by the VMs and/or the executable containers.

Multiple instances of such virtualized controllers can coordinate within a cluster to form the distributed storage system 792 which can, among other operations, manage the storage pool 790. This architecture further facilitates efficient scaling in multiple dimensions (e.g., in a dimension of computing power, in a dimension of storage space, in a dimension of network bandwidth, etc.).

A particularly-configured instance of a virtual machine at a given node can be used as a virtualized controller in a hypervisor-assisted virtualization environment to manage storage and I/O (input/output or IO) activities of any number or form of virtualized entities. For example, the virtualized entities at node 781₁₁ can interface with a controller virtual machine (e.g., virtualized controller 782₁₁) through hypervisor 785₁₁ to access data of storage pool 790. In such cases, the controller virtual machine is not formed as part of specific implementations of a given hypervisor. Instead, the controller virtual machine can run as a virtual machine above the hypervisor at the various node host computers. When the controller virtual machines run above the hypervisors, varying virtual machine architectures and/or hypervisors can operate with the distributed storage system 792. For example, a hypervisor at one node in the distributed storage system 792 might correspond to software from a first vendor, and a hypervisor at another node in the distributed storage system 792 might correspond to a second software vendor. As another virtualized controller implementation example, executable containers can be used to implement a virtualized controller (e.g., virtualized controller 782_{1M}) in an operating system virtualization environment at a given node. In this case, for example, the virtualized entities at node 781_{1M} can access the storage pool 790 by interfacing with a controller container (e.g., virtualized controller 782_{1M}) through hypervisor 785_{1M} and/or the kernel of host operating system 787_{1M}.

In certain embodiments, one or more instances of an agent can be implemented in the distributed storage system 792 to facilitate the herein disclosed techniques. Specifically, agent 784₁₁ can be implemented in the virtualized controller 782₁₁, and agent 784_{1M} can be implemented in the virtualized controller 782_{1M}. Such instances of the virtualized controller can be implemented in any node in any cluster. Actions taken by one or more instances of the virtualized controller can apply to a node (or between nodes), and/or to a cluster (or between clusters), and/or between any resources or subsystems accessible by the virtualized controller or their agents.

Solutions attendant to implementation of placeholder-aware placement engines that observe rules covering placement requirements for high-availability computing clusters can be brought to bear through implementation of any one or more of the foregoing techniques. Moreover, any aspect or aspects of HA-aware placement requirements can be implemented in the context of the foregoing environments.

In the foregoing specification, the disclosure has been described with reference to specific embodiments thereof. It will, however, be evident that various modifications and changes may be made thereto without departing from the broader spirit and scope of the disclosure. For example, the above-described process flows are described with reference to a particular ordering of process actions. However, the ordering of many of the described process actions may be changed without affecting the scope or operation of the disclosure. The specification and drawings are to be regarded in an illustrative sense rather than in a restrictive sense.

What is claimed is:

1. A non-transitory computer readable medium having stored thereon a sequence of instructions which, when stored in memory and executed by a processor cause the processor to perform acts comprising:
hosting a virtual machine in a source computing node of a virtualized high-availability multi-node computing cluster;
responding to a virtual machine migration request by:
establishing a placeholder at a target computing node of the virtualized high-availability multi-node computing cluster, wherein the placeholder corresponds to reserved resources of the target computing node; and
migrating the virtual machine from the source computing node to the target computing node using the reserved resources.

2. The non-transitory computer readable medium of claim 1, wherein the virtual machine migration request corresponds to a placement to satisfy a high-availability requirement.

3. The non-transitory computer readable medium of claim 2, wherein the high-availability requirement corresponds to at least one of, any number of anti-affinity rules, or any number of high-availability reboot rules.

4. The non-transitory computer readable medium of claim 1, wherein establishing the placeholder at the target computing node prevents allocating the reserved resources of the target computing node to any entity other than the virtual machine.

5. The non-transitory computer readable medium of claim 1, wherein the virtual machine migration request corresponds to a resource demand to increase resources available to the virtual machine when the source computing node cannot fulfill the resource demand using resources available at the source computing node.

6. The non-transitory computer readable medium of claim 1, wherein the virtual machine migration request corresponds to a requirement to satisfy a placeholder placement rule.

7. The non-transitory computer readable medium of claim 6, wherein placeholder placement rule corresponds to at least one of, a scheduler resource reservation awareness rule, or a hypervisor resource reservation awareness rule.

8. The non-transitory computer readable medium of claim 1, wherein the target computing node has fewer available resources than the source computing node and further comprising instructions which, when stored in memory and executed by the processor cause the processor to perform further acts of migrating a further virtual machine from the target computing node to a further target computing node.

9. The non-transitory computer readable medium of claim 1, wherein the migrating of the virtual machine from the source computing node to the target computing node using the reserved resources observes high-availability requirements.

10. A method comprising:
hosting a virtual machine in a source computing node of a virtualized high-availability multi-node computing cluster;
responding to a virtual machine migration request by:
establishing a placeholder at a target computing node of the virtualized high-availability multi-node computing cluster, wherein the placeholder corresponds to reserved resources of the target computing node; and
migrating the virtual machine from the source computing node to the target computing node using the reserved resources.

11. The method of claim 10, wherein the virtual machine migration request corresponds to a placement to satisfy a high-availability requirement.

12. The method of claim 11, wherein the high-availability requirement corresponds to at least one of, any number of anti-affinity rules, or any number of high-availability reboot rules.

13. The method of claim 10, wherein establishing the placeholder at the target computing node prevents allocating the reserved resources of the target computing node to any entity other than the virtual machine.

14. The method of claim 10, wherein the virtual machine migration request corresponds to a resource demand to increase resources available to the virtual machine when the source computing node cannot fulfill the resource demand using resources available at the source computing node.

15. The method of claim 10, wherein the virtual machine migration request corresponds to a requirement to satisfy a placeholder placement rule.

16. The method of claim 15, wherein placeholder placement rule corresponds to at least one of, a scheduler resource reservation awareness rule, or a hypervisor resource reservation awareness rule.

17. The method of claim 10, wherein the target computing node has fewer available resources than the source computing node and wherein the method further comprises migrating a further virtual machine from the target computing node to a further target computing node.

18. The method of claim 10, wherein the migrating of the virtual machine from the source computing node to the target computing node using the reserved resources observes high-availability requirements.

19. A system comprising:
a storage medium having stored thereon a sequence of instructions; and
a processor that executes the sequence of instructions to cause the processor to perform acts comprising,
hosting a virtual machine in a source computing node of a virtualized high-availability multi-node computing cluster;
responding to a virtual machine migration request by:
establishing a placeholder at a target computing node of the virtualized high-availability multi-node computing cluster, wherein the placeholder corresponds to reserved resources of the target computing node; and
migrating the virtual machine from the source computing node to the target computing node using the reserved resources.

20. The system of claim 19, wherein the virtual machine migration request corresponds to a placement to satisfy a high-availability requirement.

21. The system of claim 20, wherein the high-availability requirement corresponds to at least one of, any number of anti-affinity rules, or any number of high-availability reboot rules.

22. The system of claim 19, wherein establishing the placeholder at the target computing node prevents allocating the reserved resources of the target computing node to any entity other than the virtual machine.

23. The system of claim 19, wherein the virtual machine migration request corresponds to a resource demand to increase resources available to the virtual machine when the source computing node cannot fulfill the resource demand using resources available at the source computing node.

24. The system of claim 19, wherein the virtual machine migration request corresponds to a requirement to satisfy a placeholder placement rule.

25. The system of claim 24, wherein placeholder placement rule corresponds to at least one of, a scheduler resource reservation awareness rule, or a hypervisor resource reservation awareness rule.

26. The system of claim 19, wherein the target computing node has fewer available resources than the source computing node and further comprising instructions which, when stored in memory and executed by the processor cause the processor to perform further acts of migrating a further virtual machine from the target computing node to a further target computing node.

27. The system of claim 19, wherein the migrating of the virtual machine from the source computing node to the target computing node using the reserved resources observes high-availability requirements.
